(19) United States
(12) Patent Application Publication
(10) Pub. No.: US 2007/0291467 A1
(43) Pub. Date: Dec. 20, 2007

(54) Illumination Source

(76) Inventors: Hideo Nagai, Osaka (JP); Kenji Mukai, Osaka (JP)

Correspondence Address: SNELL & WILMER L.L.P. (Matsushita), 600 ANTON BOULEVARD, SUITE 1400, COSTA MESA, CA, 92626, US

(21) Appl. No.: 11/596,034

(22) PCT Filed: Jun. 10, 2005
(86) PCT No.: PCT/JP05/11080

§ 371 Date: Jun. 28, 2007

(30) Foreign Application Priority Data
Jun. 29, 2004 (JP) 2004-192153

(51) Int. Cl. F21V 9/16; F21V 9/00

(52) U.S. Cl. 362/84; 362/231

(57) ABSTRACT

An illumination source is composed of a white LED of a first light source color and an orange LED of a second light source color, so that light is emitted in a color created as a result of mixing the first and second light source colors. The first and second light source colors are represented on the 1931 CIE chromaticity diagram by a first point P1 and a second point P2, respectively. The first point P1 is substantially on the Planckian Locus PL. The second point P2 is at such a position that a line segment L1 connecting the first and second points P1 and P2 is substantially in parallel with a tangent line L3 to the Planckian Locus PL. The tangent line L3 has a point of tangency on a line L2 that is normal to the Planckian Locus PL and passes through the first point P1.

### TECHNICAL FIELD

The present invention relates to an illumination source, and especially to an illumination source of which light source color (correlated color temperature) is variable.

### BACKGROUND ART

Through the years, there has been a demand for altering the light source color (correlated color temperature) of room illumination at households and workplaces, in accordance with the season, the time of day, and the occasion. Regarding the seasons, for example, a cool color such as whitish light may be suitable for summer seasons, whereas a warm color such as reddish light may be suitable for winter seasons. Regarding the time of day, a daylight color may be suitable during work hours because the color is said to help improving the work efficiency. During a break, on the other hand, an incandescent lamp color may be suitable because the color is relaxing.

Considering the purpose of room illumination, it is desirable to vary the light source color while maintaining a natural appearance as much as possible. In other words, it is desirable that the light source color vary so as to precisely or generally trace the Planckian Locus on the 1931 CIE chromaticity diagram.

Conventionally, the majority of room illumination sources are fluorescent lamps. Unfortunately, however, the light source colors of fluorescent lamps are fixedly determined depending on the mixing ratio of different phosphors. Thus, in order to change the light source color of a fluorescent lamp currently used for room illumination, the fluorescent lamp itself needs to be replaced with a fluorescent lamp having a desired light source color each time such a change is requested, which is too much trouble.

In view of the above, attention is being given to LEDs, which are now available in all three primary colors of red, green, and blue, thanks to recently introduced high-efficiency blue LEDs. A light source composed of a plurality of red, green, and blue LEDs arranged close to one another will produce light of a desired color as a result of mixture of red, green, and blue light (see, for example, JP Patent Application Publication No. 2004-6253). On the 1931 CIE chromaticity diagram, the light source colors of red, green, and blue LEDs are represented by apexes of a triangle encompassing the Planckian Locus. Consequently, by adjusting the relative light intensities of LEDs of the respective colors (a power supply to each LED), the light source color can be varied so as to precisely or generally follow the Planckian Locus. That is to say, a single light source can generate light of a variable color while maintaining the light close to natural light.

However, with the use of red, green, and blue LEDs, it is required to delicately control the proportions of three colors, i.e. the proportions of power supplies to the LEDs. In order to perform such delicate control, a costly control system is required.

In view of the above problems, the present invention aims to provide an illumination source of which light source color is variable in a state close to natural light, with easier control than conventionally required.

### DISCLOSURE OF THE INVENTION

An illumination source according to the present invention includes: a first light source operable to emit light of a first color represented by a first point on a 1931 CIE chromaticity diagram; and a second light source operable to emit light of a second color represented by a second point on the 1931 CIE chromaticity diagram, a light intensity of the second light source being variable in accordance with a power supply. The first point is substantially on a Planckian Locus. The second point is at such a position that a line segment connecting the first and second points is substantially in parallel with a tangent line to the Planckian Locus, the tangent line having a point of tangency on a line that is normal to the Planckian Locus and passes through the first point. The illumination source emits light of a mixture color of the first and second colors.

With the structure stated above, the light source color of the illumination source changes to a color represented by an arbitrary point on the line segment, simply by varying the power supply to the second light source. That is to say, the light source color is variable without deviating much from the Planckian Locus on the chromaticity diagram, i.e. within a state close to natural light.

### BRIEF DESCRIPTION OF THE DRAWINGS

FIG. 1 are views for illustrating the principles of the present invention;

FIG. 2 is a graph showing, for each of examples, the correlated color temperature plotted against the general color rendering index;

FIG. 3 is a graph showing, for each of examples, the correlated color temperature plotted against the general color rendering index;

FIG. 4A is a plan view, FIG. 4B is a front view, and FIG. 4C is a circuit diagram of an illumination source according to an embodiment 1;

FIG. 5 is a diagram showing the spectral distributions of light emitted by respective illuminants constituting the illumination source according the embodiment 1;

FIG. 6 are chromaticity diagrams and tables showing data relating to the illumination source according the embodiment 1;

FIG. 7 is a diagram showing the spectral distributions of light emitted by respective illuminants constituting an illumination source according an embodiment 2;

FIG. 8 are chromaticity diagrams and tables showing data relating to the illumination source according the embodiment 2;

FIG. 9A is a plan view, FIG. 9B is a front view, and FIGS. 9C and 9D are circuit diagrams of the illumination source according to the embodiment 2;

FIG. 10 is a diagram showing the spectral distribution of light emitted by an orange LED array constituting an illumination source of an example 3;

FIG. 11A is a diagram showing the spectral distribution of light emitted solely by a white LED array constituting the illumination source of the example 3, and FIG. 11B includes a chromaticity diagram and tables showing related data;

FIG. 12A is a diagram showing the spectral distribution of light emitted by causing both the white and orange LED arrays constituting the illumination source of the example 3, and FIG. 12B includes a chromaticity diagram and tables showing related data;

FIG. 13 is a diagram showing the spectral distribution of light emitted by an orange LED array constituting an illumination source of an example 4;

FIG. 14 are chromaticity diagrams and tables showing data relating to the illumination source of the example 4;

FIG. 15 is a diagram showing the spectral distribution of light emitted by an orange LED array constituting an illumination source of an example 5;

FIG. 16 are chromaticity diagrams and tables showing data relating to the illumination source of the example 5;

FIG. 17 is a diagram showing the spectral distribution of light emitted by an orange LED array constituting an illumination source of an example 6;

FIG. 18A is a diagram showing the spectral distribution of light emitted solely by a white LED array constituting the illumination source of the example 6, and FIG. 18B includes a chromaticity diagram and tables showing related data;

FIG. 19A is a diagram showing the spectral distribution of light emitted by causing both the white and orange LED arrays constituting the illumination source of the example 6, and FIG. 19B includes a chromaticity diagram and tables showing related data;

FIG. 20 is a diagram showing the spectral distribution of light emitted by an orange LED array constituting an illumination source of an example 7;

FIG. 21 are chromaticity diagrams and tables showing data relating to the illumination source of the example 7;

FIG. 22 is a diagram showing the spectral distribution of light emitted by an orange LED array constituting an illumination source of an example 8;

FIG. 23 are chromaticity diagrams and tables showing data relating to the illumination source of the example 8;

FIG. 24A is a diagram showing the spectral distribution of light emitted solely by a white LED array constituting an illumination source of an example 9, and FIG. 24B includes a chromaticity diagram and tables showing related data;

FIG. 25A is a diagram showing the spectral distribution of light emitted by causing both the white LED array and an orange LED array constituting the illumination source of the example 9, and FIG. 25B includes a chromaticity diagram and tables showing related data;

FIG. 26 are chromaticity diagrams and tables showing data relating to an illumination source of an example 10;

FIG. 27 are chromaticity diagrams and tables showing data relating to an illumination source of an example 11;

FIG. 28 are chromaticity diagrams and tables showing data relating to an illumination source of an example 12;

FIG. 29 are chromaticity diagrams and tables showing data relating to an illumination source of an example 13;

FIG. 30A is a plan view, FIG. 30B is a front view, and FIG. 30C is a circuit diagram of the illumination source according to the embodiment 3;

FIG. 31 is a diagram showing the spectral distribution of light emitted by a blue LED array constituting an illumination source of an example 14;

FIG. 32A is a diagram showing the spectral distribution of light emitted solely by a white LED array constituting the illumination source of the example 14, and FIG. 32B includes a chromaticity diagram and tables showing related data;

FIG. 33A is a diagram showing the spectral distribution of light emitted by causing both the white LED array and an orange LED array constituting the illumination source of the example 14, and FIG. 33B includes a chromaticity diagram and tables showing related data; and

FIG. 34A is a diagram showing the spectral distribution of light emitted by causing both the white and blue LED arrays constituting the illumination source of the example 14, and FIG. 34B includes a chromaticity diagram and tables showing related data.

### BEST MODE FOR CARRYING OUT THE INVENTION

Hereinafter, a description is given to illumination sources according to embodiments of the present invention, with reference to the accompanying drawings.

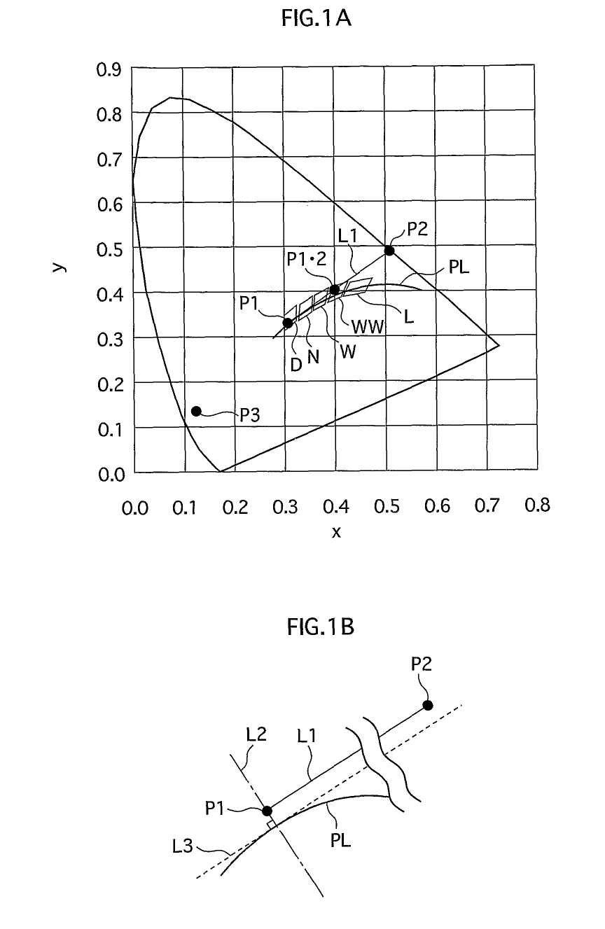

Prior to a specific description of illumination sources according to the embodiments, the principles of the present invention will be described with reference to FIG. 1. FIG. 1A is the 1931 CIE chromaticity diagram (hereinafter, this specific 1931 CIE chromaticity diagram is simply referred to as the “chromaticity diagram”).

An illumination source according to the present invention basically has a first light source and a second light source. On the chromaticity diagram, the color of the first light source is represented by a first point P1, whereas the color of the second light source is represented by a second point P2. By causing the first light source to solely emit light, the first light source color is obtained. By causing both the first and second light sources to emit light at the same time, a mixture of the first and second light source colors is produced.

The first point P1 is substantially on the Planckian Locus PL. The wording “substantially on” means that the first point P1 is located, on the CIE 1960uv chromaticity diagram, within a range of −5≦duv≦10, where duv (chromaticity deviation) is a result obtainedby multiplying a distance from the Planckian Locus by 1000. (Note that duv takes on a positive value when the first point P1 is above the Planckian Locus along the Y axis, and a negative value when the first point P1 is below the Planckian Locus.) The above range of −5≦duv≦10 substantially coincides with a range of deviation, from the Planckian Locus, of the chromaticity regions of five typical light source colors (daylight, daylight white, white, warm white, and incandescent lamp colors) of fluorescent lamps defined in Japanese Industrial Standard (JIS): Z9112. That is, one principal application of the illumination source of the present invention is to be used as a replacement for a fluorescent lamp. Note that five quadrilaterals in FIG. 1A represent the chromaticity regions of the five colors defined in JIS mentioned above, namely daylight D, daylight white W, white W, warm white WW, and incandescent lamp color L. The correlated color temperatures of the five light source colors fall within a range of the lowest of 2600 K to the highest of 7100 K. The illumination source of the present application is designed to have a light source color of which correlated color temperature varies within the above-specified range.

Next, the position of the second point P2 is described by additionally referencing to FIG. 1B. FIG. 1B is an enlarged view of the first point P1 and its nearby area. The second point P2 resides at such a position that a line segment L1 connecting the points P1 and P2 is substantially in parallel with a line L3 tangent to the Planckian Locus PL at a point on a line L2. The line L2 is normal to the Planckian Locus PL and passes through the first point P1.

Here, a description is given to the meaning of “the line segment L1 is substantially in parallel with the tangent line L3”. The first light source color corresponds to the first point P1, whereas the second light source color corresponds to the second point P2. Combination of the first and second light source colors results in the creation of a color (determined depending on the proportions of the two colors) represented by the coordinates locating a point (point P1•2) on the line segment L1 connecting the chromaticity coordinates of the two colors. In the following embodiments, the first light source is always made to emit light, whereas the second light source is made to emit light at a varying intensity (relative intensity) so as to obtain a desired light source color (color temperature). In order to keep the point P1•2 within the range of −5≦duv≦10 as much as possible, the line segment L1 is required to extend along the Planckian Locus PL. The wording “the line segment L1 is substantially in parallel with the tangent line L3” means that the line segment L1 is made to extend along the tangent line L3 so that the point P1•2 falls in the range of −5≦duv≦10. In other words, it is sufficient that the line segment L1 is in parallel with the tangent line L3 (i.e. the line segment L1 and the tangent line L3 extend in a substantially same direction) to an extent that the point P1•2 falls in the range of −5≦duv≦10 as the light intensity of the second light source is made to vary relative to the first light source. The wording “substantially in parallel” is used to express the above meaning.

Furthermore, the wording “substantially in parallel” includes cases where the line segment L1 intersects the Planckian Locus PL. Specifically, the wording include cases where (i) the first point P1 is on the Planckian Locus PL and the line segment L1 intersects the Planckian Locus PL once, (ii) the first point P1 is inside the Planckian Locus PL that smoothly curves and the line segment L1 intersects the Planckian Locus PL once, (iii) the first point P1 is outside the Planckian Locus PL that smoothly curves and the line segment L1 intersects the Planckian Locus PL twice, and (iv) the first point P1 is outside the Planckian Locus PL that smoothly curves and the line segment L1 is tangent to the Planckian Locus PL.

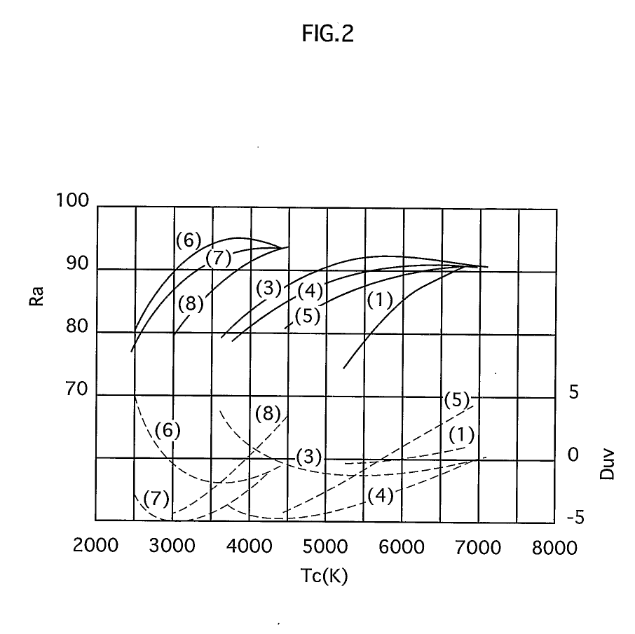

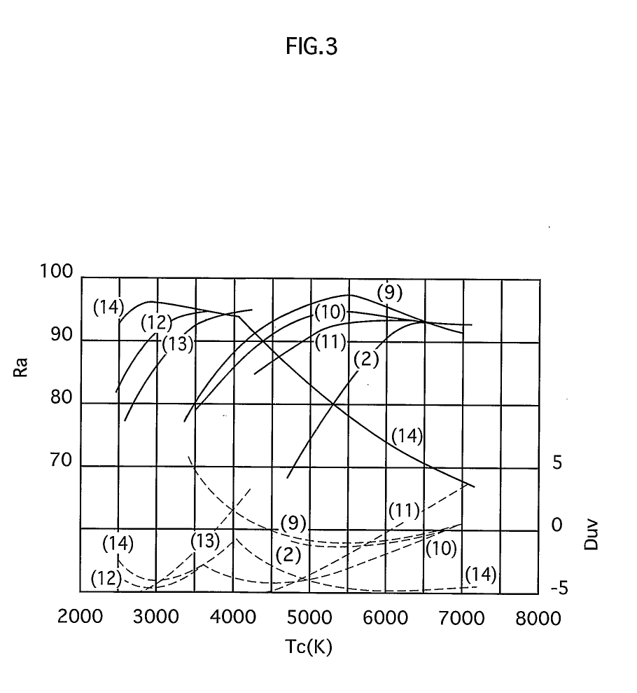

FIGS. 2 and 3 are graphs showing, regarding each of illumination sources of later-described specific examples, the light source color (correlated color temperature Tc and chromaticity deviation duv) plotted against the general color rendering index Ra, as the light intensity of the second light source is varied relatively to the first light source. Numbers in parentheses correspond to the examples. References will be made to FIGS. 2 and 3 as necessary in a description of each example.

### EMBODIMENT 1

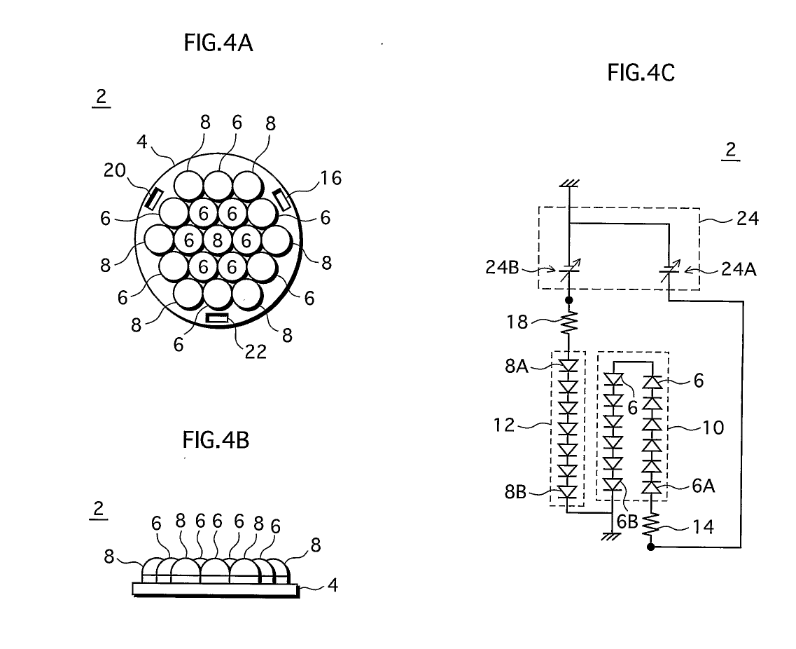

FIG. 4A is a plan view and FIG. 4B is a front view both showing the schematic structure of an illumination source 2 according to an embodiment 1.

The illumination source 2 is composed of a multi-layer printed wiring board 4 (hereinafter, simply “printed wiring board 4”) and light emitting elements which are white LEDs 6 and orange LEDs 8 mounted on the printed wiring board 4. Specifically, twelve white LEDs 6 and seven orange LEDs 8 are mounted. Each of the LEDs 6 and 8 is so-called a bullet-shaped LED. The white LEDs 6 and the orange LEDs 8 are electrically connected by the wiring (not illustrated) of the printed wiring board 4, as shown in a circuit diagram of FIG. 4C. More specifically, the twelve white LEDs 6 are serially connected (the serially connected twelve white LEDs 6 are correctively referred to as a “white LED array 10”) and the seven orange LEDs 8 are serially connected (the serially connected seven orange LEDs 8 are collectively referred to as an “orange LED array 12”). In the embodiment 1, the first light source is constituted by the white LED array 10, whereas the second light source is constituted by the orange LED array 12.

The anode of a white LED 6A which is positioned at the high-potential end of the white LED array 10 is connected to a power supply terminal 16 across a limited resistance 14 (not shown in FIG. 4A) mounted on the printed wiring board 4. The anode of an orange LED 8A which is positioned at the high-potential end of the orange LED array 12 is connected to a power supply terminal 20 across a limited resistance 18 (not shown in FIG. 4A) mounted on the printed wiring board 4. In addition, the cathode of a white LED 6B and the cathode of an orange LED 8B are both connected to a common terminal 22 by the wiring (not illustrated) of the printed wiring board 4. The white LED 6B and the orange LED 8B are positioned at the low-potential ends of the respective LED arrays 10 and 12.

The illumination source 2 having the above structure is driven by a variable power device 24 known in the art. Specifically, the variable power device 24 has variable power units 24A and 24B for controlling the power supply to the power supply terminals 16 and 20, respectively. By separately controlling the power supply to the respective power supply terminals, only one of the LED arrays may be made to illuminate or both the LED arrays may be made to illuminate at the same time. Furthermore, when both the LED arrays are made to concurrently illuminate, the relative light intensities of the LED arrays may be adjusted. As shown in FIG. 4A, the white LEDs 6 and the orange LEDs 8 are arranged close to one another in a well-balanced pattern. Thus, the illumination source 2 emits light in a light source color created as a result of sufficiently mixing the white light from the white LEDs 6 and the orange light from the orange LEDs 8. Preferably, the drive current for LEDs is controlled by pulse-width modulation (PWM). That is, the variable power device 24 is preferably controllable by PWM. With the PWM control, wavelength shifts are prevented from occurring when the power supply is varied.

As later described, each white LED 6 is composed of predetermined phosphors packaged with a blue LED chip emitting blue light or with a near-ultraviolet (NUV) LED chip emitting near-ultraviolet light. The white LED 6 emits white light created as a combination of a color of light emitted directly by the chip and a color of light converted by the phosphors. On the other hand, each orange LED 8 is composed of a packaged orange LED chip, and emits orange light as directly emitted by the orange LED chip. In the present embodiment, a GaInN-based LED is used as the blue LED chip and NUV LED chip mentioned above, whereas an AlGaInP-based LED is used as the orange LED chip mentioned above.

Regarding the white LEDs 6, used in combination with a blue LED chip are green and red phosphors that convert blue light to green and red light, respectively. The phosphor of each color used in this embodiment is expressed by the following chemical formula.

| | |
|---|---|
| Green Phosphor | (Sr, Ba, Ca)₂SiO₄: Eu²⁺ |
| | Hereinafter, ssimnply “Green SSY” |
| Red Phosphor | Sr₂Si₅N₈: Eu²⁺ |
| | Hereinafter, simply “Red NS” |

In addition, used in combination with an NUV LED chip are blue, green, yellow, and red phosphors that convert near-ultraviolet light to blue, green, yellow, and red light, respectively. The phosphor of each color used in this embodiment is expressed by the following chemical formula.

| | |
|---|---|
| Green Phosphor | BaMgAl₁₀O₁₇: Eu²⁺, Mn²⁺ |
| | Hereinafter, simply “Green BTM” |
| Red Phosphor | Sr₂Si₅N₈: Eu²⁺ |
| | Hereinafter, simply “Red NS” |
| Blue Phosphor | (Ba, Sr)₂MgAl₁₀O₁₇: Eu²⁺ |
| | Hereinafter, simply “Blue BAT” |
| Yellow Phosphor | (Sr, Ba, Ca)₂SiO₄: Eu²⁺ |
| | Hereinafter, simply “Yellow SSY” |

Now, a description is given to specific examples which fall within the scope of the embodiment 1.

### EXAMPLE 1

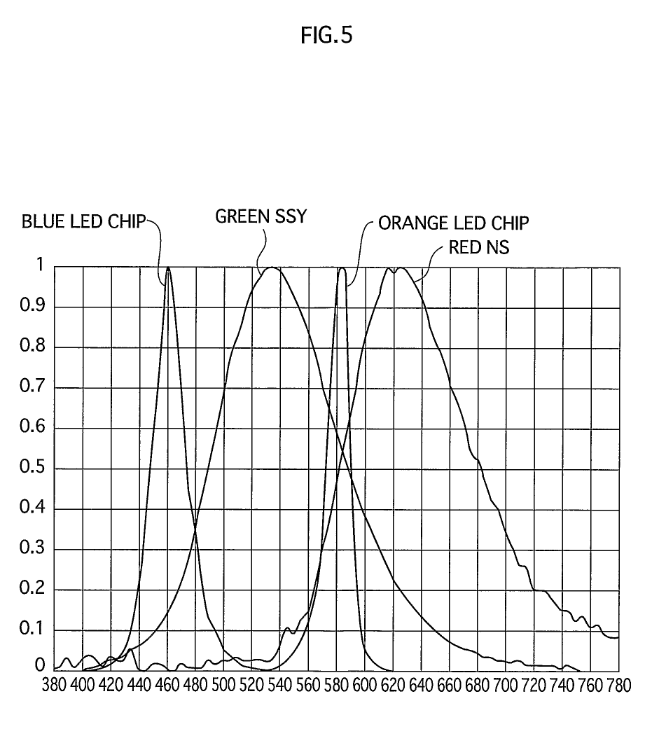

FIG. 5 is a diagram showing the spectral distributions of light emitted by the blue LED chip, the green phosphor (Green SSY), the red phosphor (Red NS), and the orange LED chip all used in an example 1. In FIG. 5, the spectral outputs are all plotted to uniformly reach a peak of the value “1”. As shown in FIG. 5, the blue LED chip used in this example has a peak emission wavelength at 460 nm and the orange LED chip has a peak emission wavelength at 585 nm. The spectral distributions of the respective colors of light emitted by the green phosphor (Green SSY) and the red phosphor (Red NS) are as shown in FIG. 5.

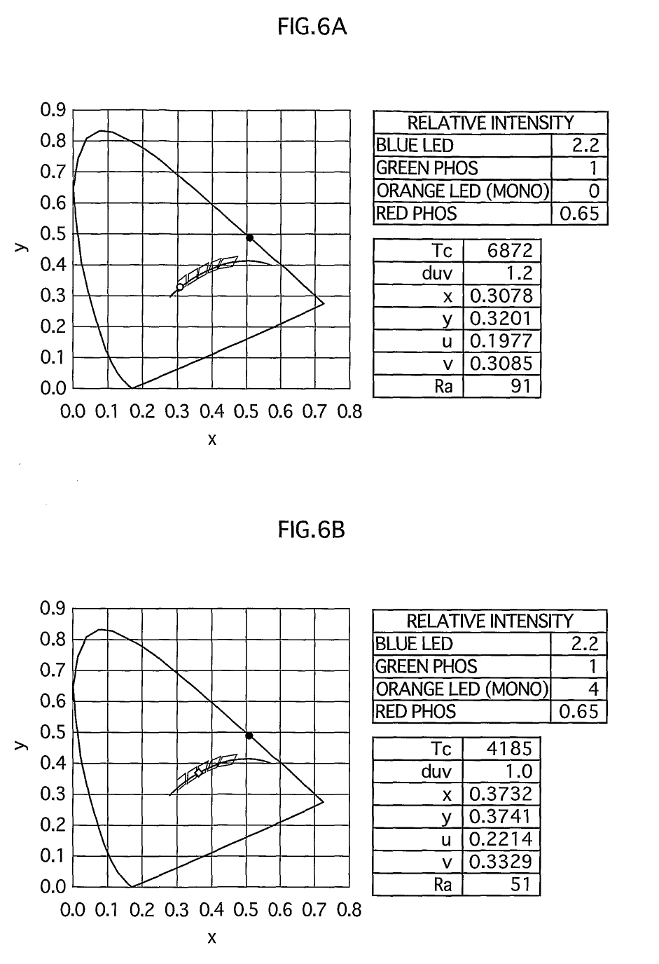

In the case where the illumination source 2 of the example 1 is made to illuminate solely by the white LED array 10 (FIG. 4), the relative intensities of the blue light (blue LED chip), the green light (green phosphor), and the red light (red phosphor) are as shown in FIG. 6A (in the drawings, the word “phosphor” may be abbreviated as “phos”). The resultant white light exhibits the correlated color temperature Tc of 6872 K (chromaticity deviation duv=1.2) and the general color rendering index Ra of 91. Note that the relative intensities are the ratios of the peak wavelength values of the respective color components of the white light. The x and y coordinates specified in the figure locate the light source color on the chromaticity diagram (1931 CIE chromaticity diagram), and the u and v coordinates locate the light source color on the CIE 1960uv chromaticity diagram (not illustrated).

On the chromaticity diagram shown in the figure, an open circle “◯” is at the position representing the light source color produced solely by the white LED array 10 (FIG. 4), which constitutes the first light source. Thus, the open circle “◯” coincides with the first point P1 mentioned above.

On the chromaticity diagram in the figure, a black circle “●” is shown at the position representing the light source color that would be produced given that the orange LED array 12 (FIG. 4), which constitutes the second light source, is made to illuminate. Thus, the black circle “●” coincides with the second point P2 mentioned above.

In the case where both the white LED array 10 and the orange LED 12 are made to illuminate at the same time, the relative intensities of the blue light (blue LED chip), the green light (green phosphor), the orange light (orange LED), and the red light (red phosphor) are as shown in FIG. 6B. The resultant white light exhibits the correlated color temperature Tc of 4185 K (chromaticity deviation duv=1.0) and the general color rendering index Ra of 51. On the chromaticity diagram in the figure, an open square “⋄” is shown at the position representing the color of the white light on the chromaticity diagram. The illumination source 2 on the whole emits light in a light source color represented by the coordinates of the open square “⋄” (hereinafter, the light source color produced by causing both the white LED array 10 and the orange LED array 12 to concurrently illuminate is referred to as a “mixture color”).

It is naturally appreciated that the mixture color may be arbitrarily varied within a wide range as indicated by the line (1) in FIG. 2, by adjusting the relative light intensity of the orange LED array 12 to the white LED array 10. When the correlated color temperature Tc is within the range of 6872≧Tc≧3100, the value of duv is maintained within the range of −5≦duv≦10. In addition, when the correlated color temperature Tc is within the range of 5600≦Tc≦6872, the general color rendering index Ra is not less than 80. When the correlated color temperature Tc is within the range of 6650≦Tc≦6872, the general color rendering index Ra is not less than 90.

In the chromaticity diagrams which will be referred to in a description of each example, the open circle “◯” indicates the position representing the light source color produced solely by the first light source (white LED array). The black circle “●” indicates the position representing the light source color that would be produced if the second light source (orange LED array) is made to solely illuminate. The open square “⋄” indicates the position representing the light source color produced by causing both the first and second light sources to illuminate at the same time.

### EXAMPLE 2

An example 2 is basically identical to the example 1, except that each white LED is composed of an NUV LED chip instead of a blue LED chip.

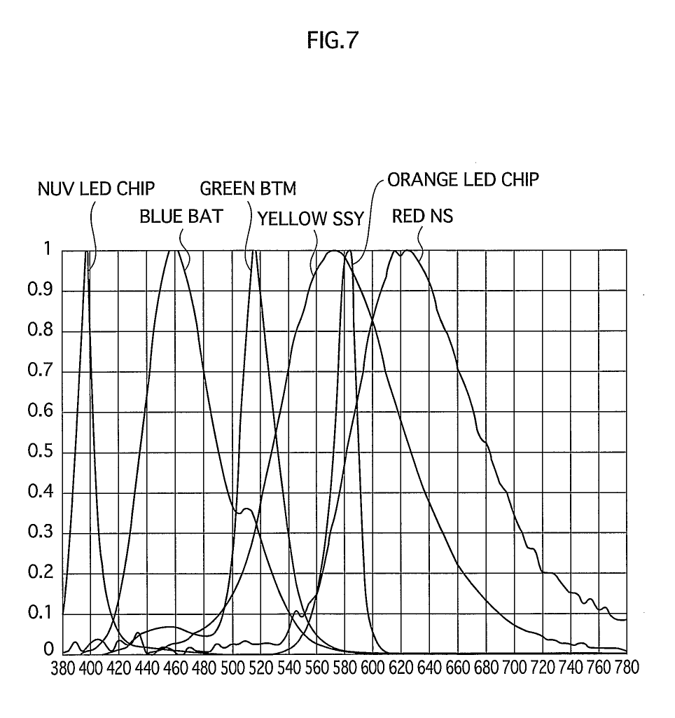

FIG. 7 is a diagram showing the spectral distributions of light emitted by the NUV LED chip, the green phosphor (Green BTM), the red phosphor (RED NS), the blue phosphor (Blue BAT), the yellow phosphor (Yellow SSY), and the orange LED chip all used in the example 2. In FIG. 7, similarly to FIG. 5, the spectral outputs are all plotted to uniformly reach a peak of the value “1”. As shown in FIG. 7, the NUV LED chip has a peak emission wavelength at 395 nm, whereas the orange LED chip has a peak emission wavelength at 585 nm, similarly to the one used in the first example. The spectral distributions of the respective colors of light emitted by the green phosphor (Green BTM), the red phosphor (Red NS), the blue phosphor (Blue BAT), and the yellow phosphor (Yellow SSY) are as shown in FIG. 7.

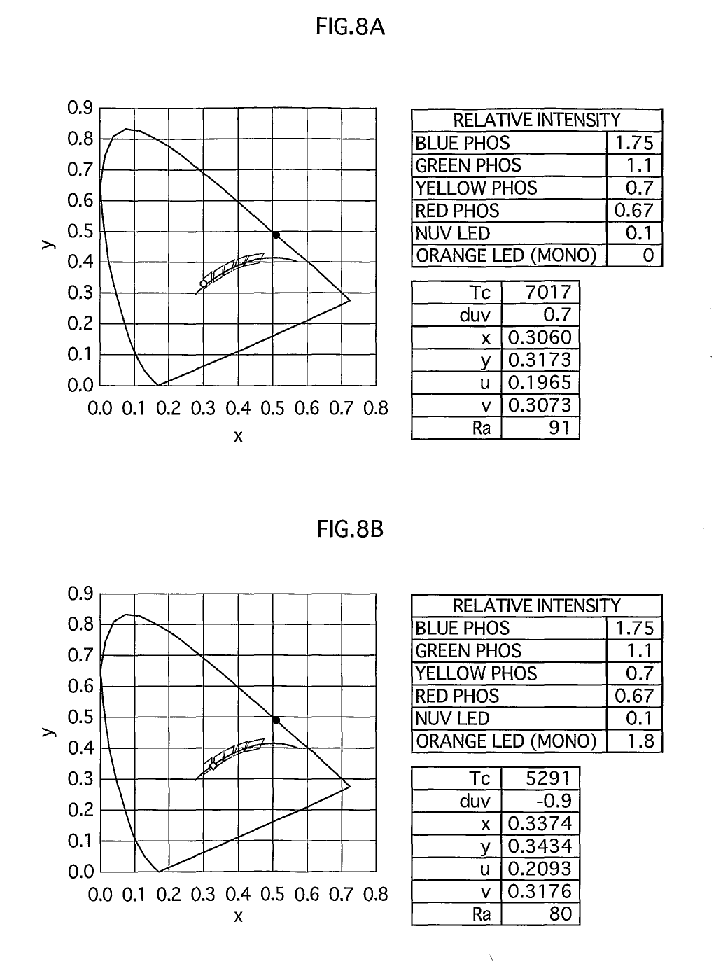

In the case where the illumination source 2 of the example 2 is made to illuminate solely by the white LED array 10 (FIG. 4), the relative intensities of the blue light (blue phosphor), the green light (green phosphor), the yellow light (yellow phosphor), the yellow light (yellow phosphor), the red light (red phosphor), and the near-ultraviolet light (NUV LED chip) are as shown in FIG. 8A. The resultant white light exhibits the correlated color temperature Tc of 7017 K (chromaticity deviation duv=0.7) and the general color rendering index Ra of 91.

In the case where both the white LED array 10 and the orange LED array 12 are made to illuminate at the same time, the relative intensities of the blue light (blue LED chip), the green light (green phosphor), the red light (red phosphor), the near-ultraviolet light (NUV LED chip), and the orange light (orange LED) are as shown in FIG. 8B. The resultant white light exhibits the correlated color temperature Tc of 5291 K (chromaticity deviation duv=−0.9) and the general color rendering index Ra of 80.

Similarly to the example 1, it is naturally appreciated that the mixture color may be arbitrarily varied within a wide range as indicated by the line (2) in FIG. 3, by adjusting the relative light intensity of the orange LED array 12 to the white LED array 10. When the correlated color temperature Tc is within the range of 7107≧Tc≧3070, the value of duv is maintained within the range of −5≦duv≦10. In addition, when the correlated color temperature Tc is within the range of 5280≦Tc≦7017, the general color rendering index Ra is not less than 80. When the correlated color temperature Tc is within the range of 5950≦Tc≦7017, the general color rendering index Ra is not less than 90.

As described above, the illumination source 2 according to embodiment 1 undergoes changes in light source color (correlated color temperature) by controlling power supplies to the white LED array 10 and the orange LED array 12 (by controlling two power supply systems). The control required herein is easier than conventional control of power supplies to LEDs of R, G, and B (control of three power supply systems). Furthermore, the correlated color temperature is variable within the above-mentioned range and the color deviation is maintained within the above-mentioned range.

### EMBODIMENT 2

An embodiment 2 of the present invention is basically similar to the embodiment 1, and the different lies mainly in the structure of the second light source (orange LED array) Accordingly, the same reference numerals are used to denote the same components, and no or brief description is given to such components. A description hereinafter focuses on the difference.

In the embodiment 1, the second light source is composed of the orange LEDs 8 (FIG. 4) all of which are of the same type. In the embodiment 2, the second light source is composed of two types of orange LEDs. The difference between the two types of orange LED lies in peak emission wavelength.

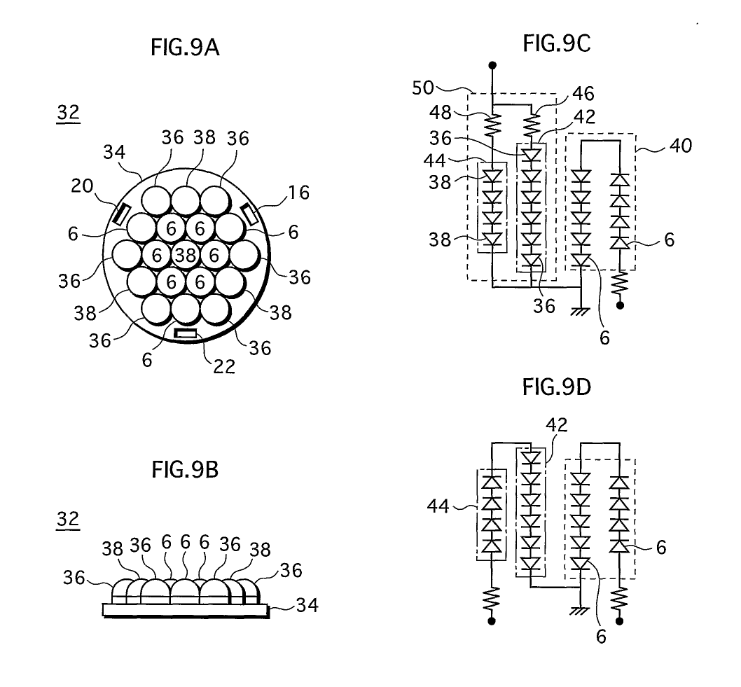

FIG. 9A is a plan view and FIG. 9B is a front view both showing the schematic structure of an illumination source 32 according to the embodiment 2.

The illumination source 32 is composed of a multi-layer printed wiring board 34 (hereinafter, simply “printed wiring board 34”), and a plurality of bullet-shaped LEDs mounted on the printed wiring board 34 in the same pattern as the embodiment 1.

Among the LEDs, six LEDs denoted by the reference numeral 36 are orange LEDs having a first peak emission wavelength and four denoted by the reference numeral 38 are orange LEDs having a second peak emission wavelength shorter than the first wavelength. Specific examples of the first and second wavelengths will be mentioned later in descriptions of examples. Note that the white LEDs 6 are identical to those used in the embodiment 1, although a smaller number of them are used in this embodiment.

The white LEDs 6 and the orange LEDs 36 and 38 are electrically connected by the wiring (not illustrated) of the printed wiring board 34, as shown in a circuit diagram of FIG. 9C. Specifically, nine white LEDs 6 are serially connected (hereinafter, the nine serially connected white LEDs 6 are collectively referred to as a “white LED array 40”). Furthermore, the six orange LEDs 36 are serially connected to constitute a first LED array 42, and the four orange LEDs 38 are serially connected to constitute a second LED array 44. The LED arrays 42 and 44 are connected in parallel across limited resistances 46 and 48 (hereinafter, the parallel connected LED arrays 42 and 44 are collectively referred to as an “orange LED array 50”). In the embodiment 2, the first light source is constituted by the white LED array 40 and the second light source is constituted by the orange LED array 50.

The resistivity ratio between the limited resistances 46 and 48 is set so as to make the first and second LED arrays 42 and 44 substantially equal to each other in light intensity (peak wavelength value). With this arrangement, the orange LED array 50 produces a light source color represented on the chromaticity diagram substantially by a midpoint between the chromaticity coordinates of the first LED array 42 and of the second LED array 44.

Hereinafter, a description is given to specific examples 3-13 which fall within the scope to the embodiment 2. Note that the white LEDs 6 used in the examples 3-8 are composed of blue LED chips, whereas the white LEDs 6 used in the examples 9-13 are composed of NUV LED chips.

### EXAMPLE 3

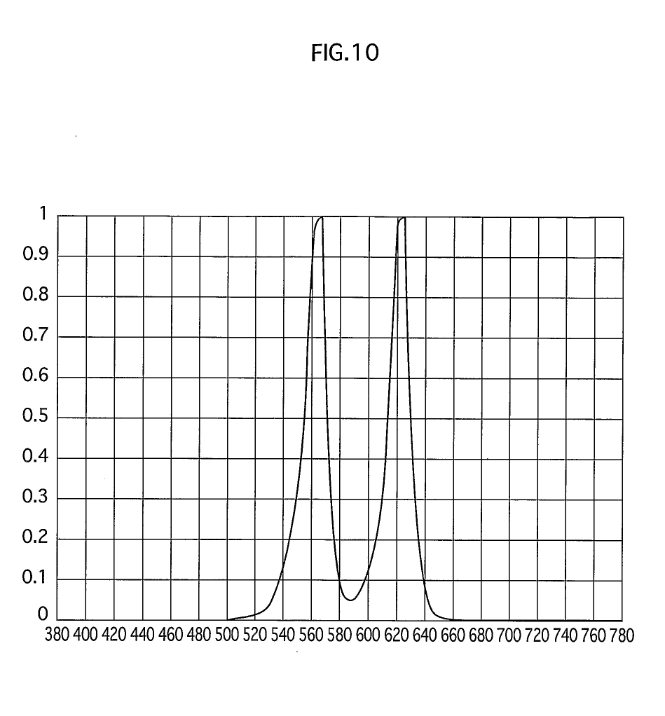

FIG. 10 is a diagram showing the spectral distribution of light emitted by the orange LED array 50 (FIG. 9) used in the example 3. The wavelength peaking at 625 nm is a wavelength component of the first LED array 42 (FIG. 9), and the wavelength peaking at 565 nm is a wavelength component of the second LED array 44 (FIG. 9).

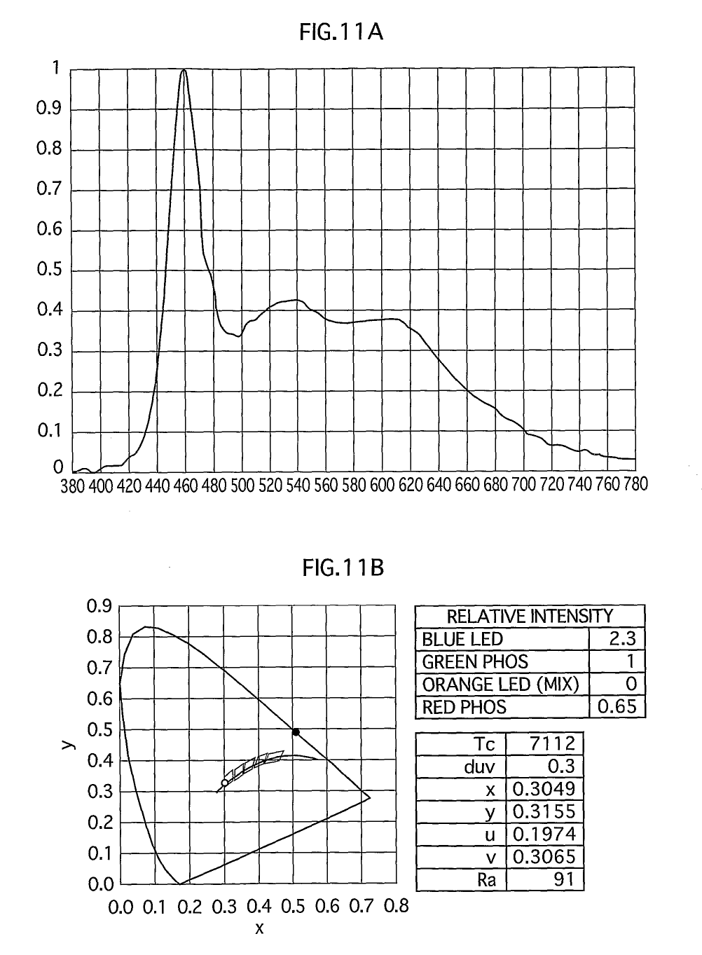

FIG. 11A is a diagram showing the spectral distribution of light emitted solely by the white LED array 40 (FIG. 9). FIG. 11B shows the coordinates of the light source color on the chromaticity diagram, along with other data. The resultant white light exhibits the correlated color temperature Tc of 7112 K (color deviation duv=0.3) and the general color rendering index Ra of 91.

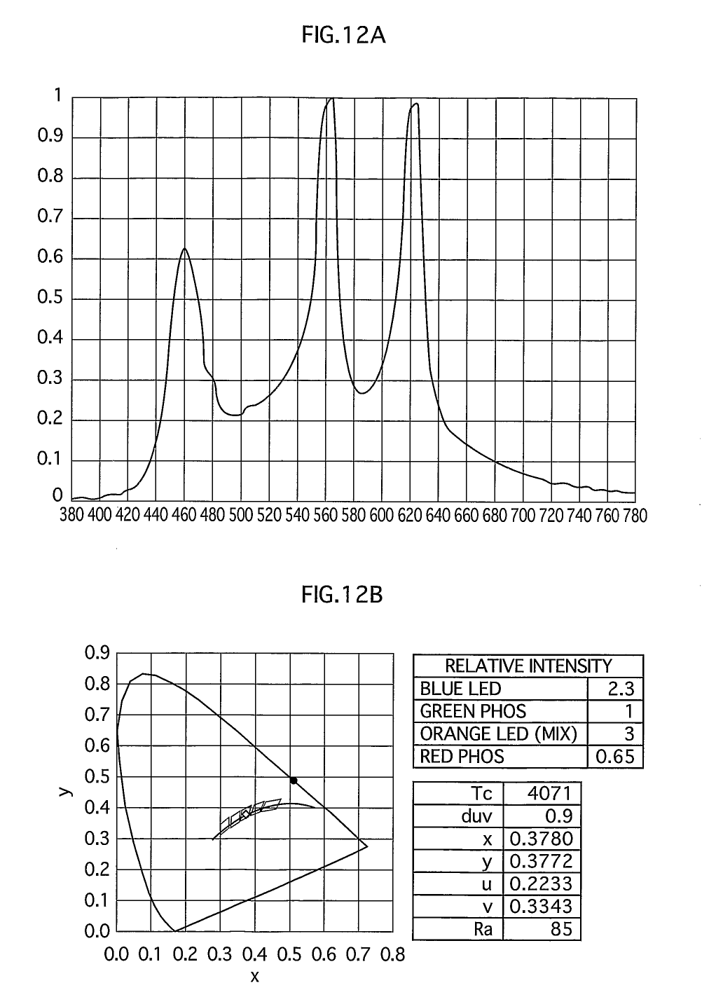

FIG. 12A is a diagram showing the spectral distribution of light emitted by causing both the white LED array 40 and the orange LED array 50 to illuminate at the same time. FIG. 12B shows the coordinates of the light source color on the chromaticity diagram, along with other data. The resultant white light exhibits the correlated color temperature Tc of 4071 K (color deviation duv=0.9) and the general color rendering index Ra of 85.

The mixture color may be arbitrarily varied within a wide range as indicated by the line (3) in FIG. 2, by adjusting the relative light intensity of the orange LED array 50 to the white LED array 40. When the correlated color temperature Tc is within the range of 7112≧Tc≧3110, the value of duv is maintained within the range of −5≦duv≦10. In addition, when the correlated color temperature Tc falls within the range of 3650≦Tc≦7112, the general color rendering index Ra is not less than 80. When the correlated color temperature Tc is within the range of 4860≦Tc≦7112, the general color rendering index Ra is not less than 90.

### EXAMPLE 4

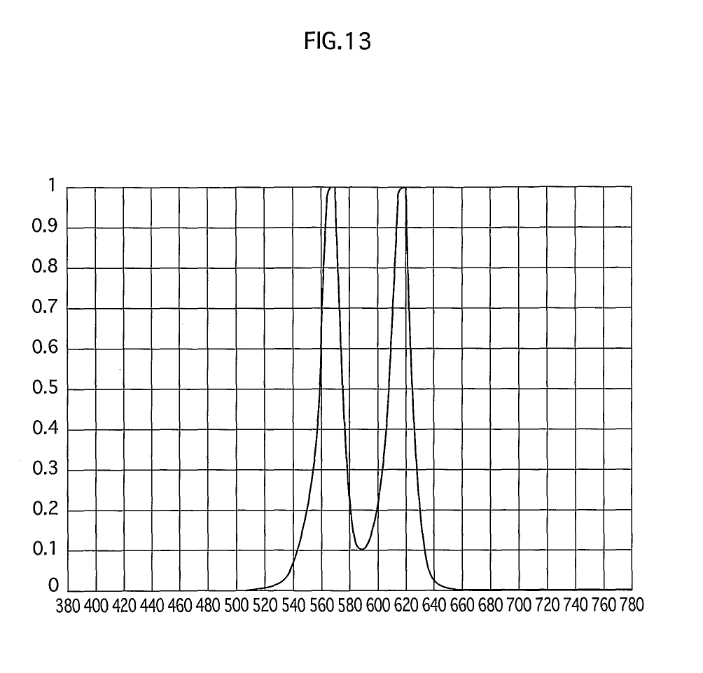

FIG. 13 is a diagram showing the spectral distribution of light emitted by the orange LED array 50 (FIG. 9) used in the example 4. The wavelength peaking at 620 nm is a wavelength component of the first LED array 42 (FIG. 9), and the wavelength peaking at 570 nm is a wavelength component of the second LED array 44 (FIG. 9).

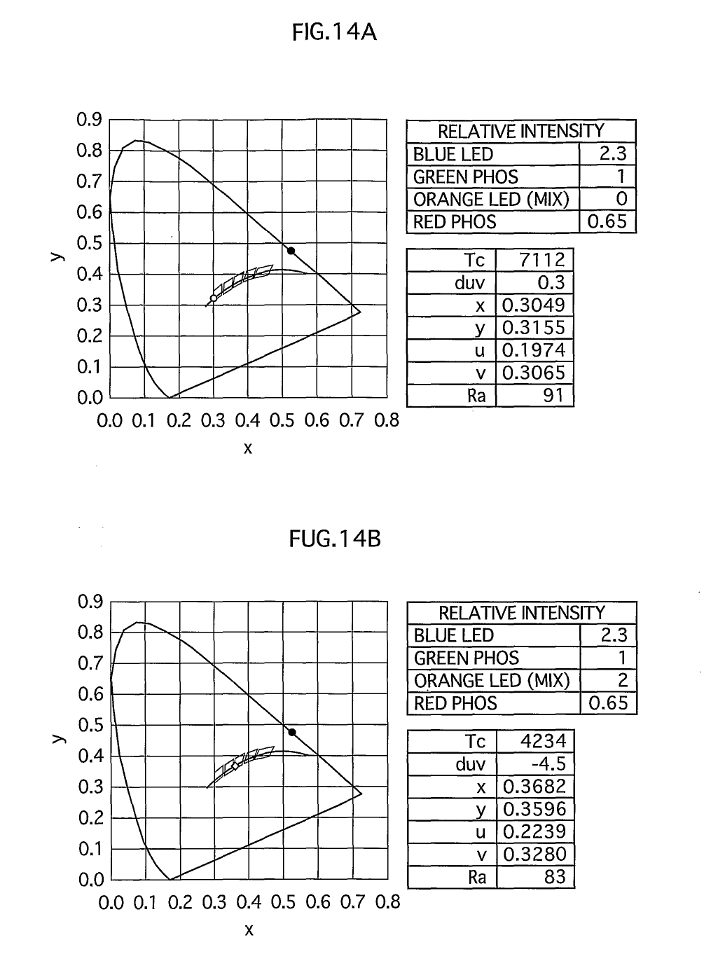

FIG. 14A shows, along with other data, the coordinates locating on the chromaticity diagram the light source color produced solely by the white LED array 40 (FIG. 9). The resultant white light exhibits the correlated color temperature Tc of 7112 K (color deviation duv=0.3) and the general color rendering index Ra of 91.

FIG. 14B shows, along with other data, the coordinates locating on the chromaticity diagram the light source color produced by causing both the white LED array 40 and the orange LED array 50 to illuminate at the same time. The resultant white light exhibits the correlated color temperature Tc of 4234 K (color deviation duv=−4.5) and the general color rendering index Ra of 83.

Furthermore, the mixture color may be arbitrarily varied within a wide range as indicated by the line (4) in FIG. 2, by adjusting the relative light intensity of the orange LED array 50 to the white LED array 40. When the correlated color temperature Tc is within the range of 7112≧Tc≧2550, the value of duv is maintained within the range of −5≦duv≦10. In addition, when the correlated color temperature Tc is within the range of 3870≦Tc≦7112, the general color rendering index Ra is not less than 80. When the correlated color temperature Tc is within the range of 5450≦Tc≦7112, the general color rendering index Ra is not less than 90.

### EXAMPLE 5

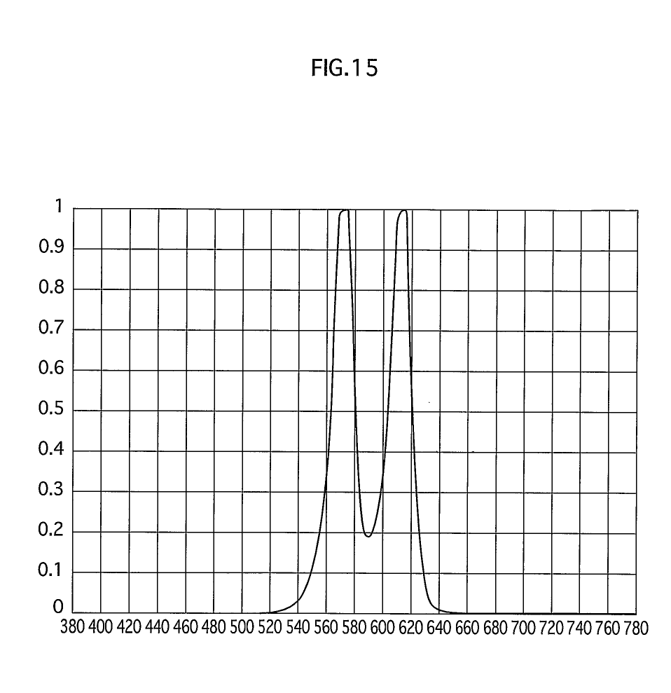

FIG. 15 is a diagram showing the spectral distribution of light emitted by the orange LED array 50 (FIG. 9) used in the example 3. The wavelength peaking at 615 nm is a wavelength component of the first LED array 42 (FIG. 9), and the wavelength peaking at 575 nm is a wavelength component of the second LED array 44 (FIG. 9).

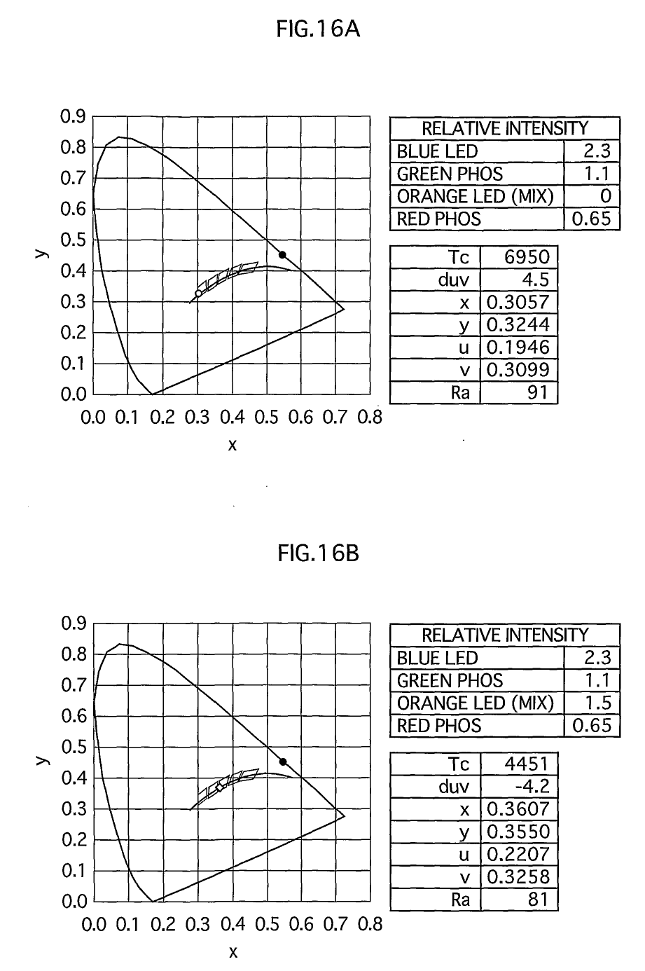

FIG. 16A shows, along with other data, the coordinates locating on the chromaticity diagram the light source color produced solely by the white LED array 40 (FIG. 9). The resultant white light exhibits the correlated color temperature Tc of 6950 K (color deviation duv=4.5) and the general color rendering index Ra of 91.

FIG. 16B shows, along with other data, the coordinates locating on the chromaticity diagram the light source color produced by causing both the white LED array 40 and the orange LED array 50 to illuminate at the same time. The resultant white light exhibits the correlated color temperature Tc of 4451 K (color deviation duv=−4.2) and the general color rendering index Ra of 81.

Furthermore, the mixture color may be arbitrarily varied within a wide range as indicated by the line (5) in FIG. 2, by adjusting the relative light intensity of the orange LED array 50 to the white LED array 40. When the correlated color temperature Tc is within the range of 6950≧Tc≧4020, the value of duv is maintained within the range of −5≦duv≦10. In addition, when the correlated color temperature Tc is within the range of 4500≦Tc≦6950, the general color rendering index Ra is not less than 80. When the correlated color temperature Tc is within the range of 6300≦Tc≦6950, the general color rendering index Ra is not less than 90.

### EXAMPLE 6

In the examples 3-5 above, the resistivity ratio between the limited resistances 46 and 48 is set so as to make the first and second LED arrays 42 and 44 shown in FIG. 9 substantially equal in light intensity (peak wavelength value).

In the example 6 and later-described examples 7 and 8, on the other hand, the resistivity ratio between the limited resistances 46 and 48 is set so as to make the first LED array 42 greater in light intensity (peak wavelength value) than the second LED array 44 (the first and second LED arrays 42 and 44 are shown in FIG. 9). With this arrangement, the position (second point) on the chromaticity diagram representing the light source color of the orange LED array 50 shifts toward longer wavelengths along the spectrum locus of monochromatic light around 560-620 nm. Thus, according to the examples 6-8, the mixture color is variable within a range of lower color temperatures than the range variable in the examples 3-5.

Note that the above arrangements to set the first and second LED arrays 42 and 44 to mutually different light intensities are exemplary and not limiting. Instead, for example, an arrangement as shown in FIG. 9D may be made. Specifically, the first and second LED arrays 42 and 44 are serially connected. In this case, the intensity ratio of the first and second LED arrays 42 and 44 is determined by the ratio of the numbers of LEDs constituting the respective LED arrays.

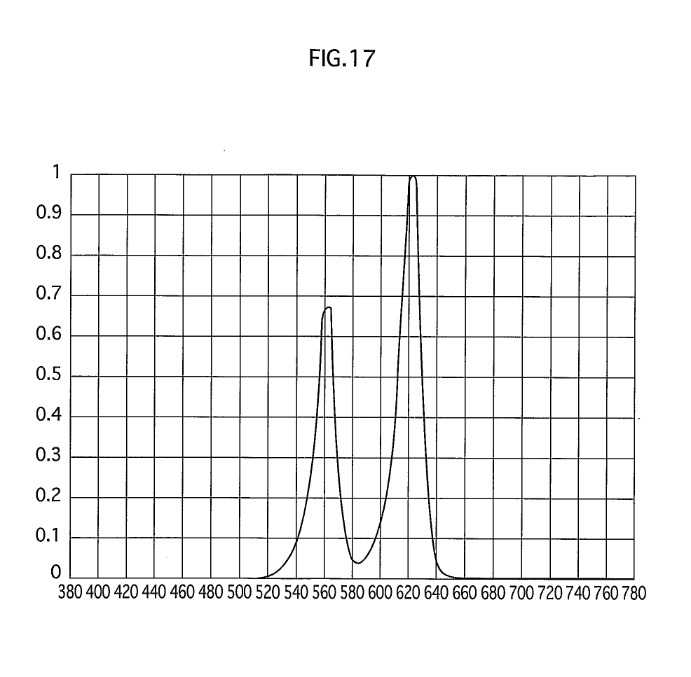

FIG. 17 is a diagram showing the spectral distribution of light emitted by the orange LED array 50 (FIG. 9) used in the example 6. The wavelength peaking at 625 nm is a wavelength component of the first LED array 42 (FIG. 9), and the wavelength peaking at 565 nm is a wavelength component of the second LED array 44 (FIG. 9).

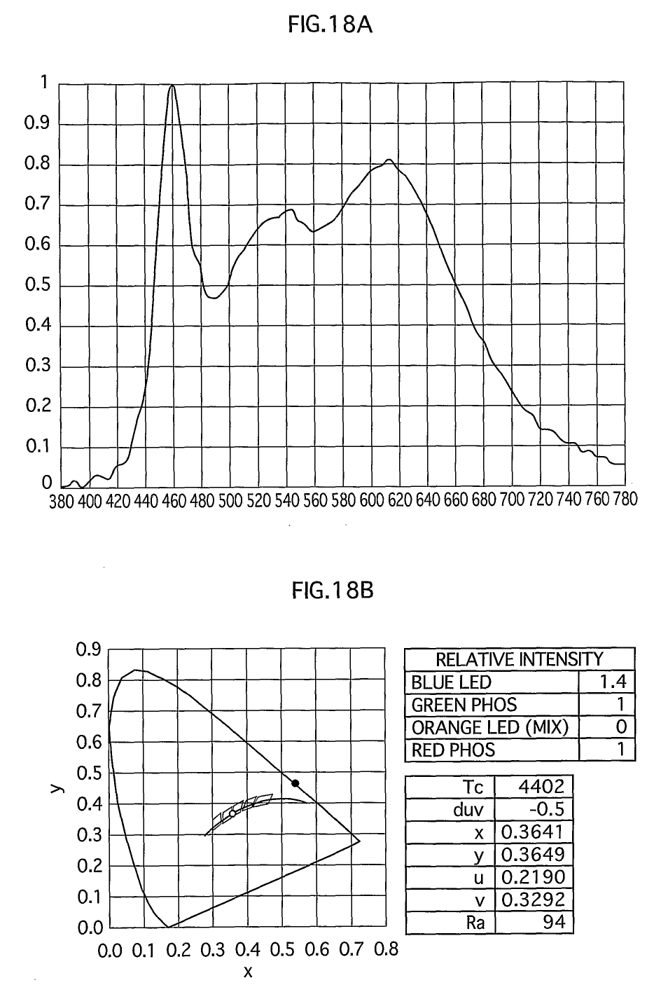

FIG. 18A is a diagram showing the spectral distribution of light emitted solely by the white LED array 40 (FIG. 9). FIG. 18B shows the coordinates of the light source color on the chromaticity diagram, along with other data. The resultant white light exhibits the correlated color temperature Tc of 4402 K (color deviation duv=−0.5) and the general color rendering index Ra of 94.

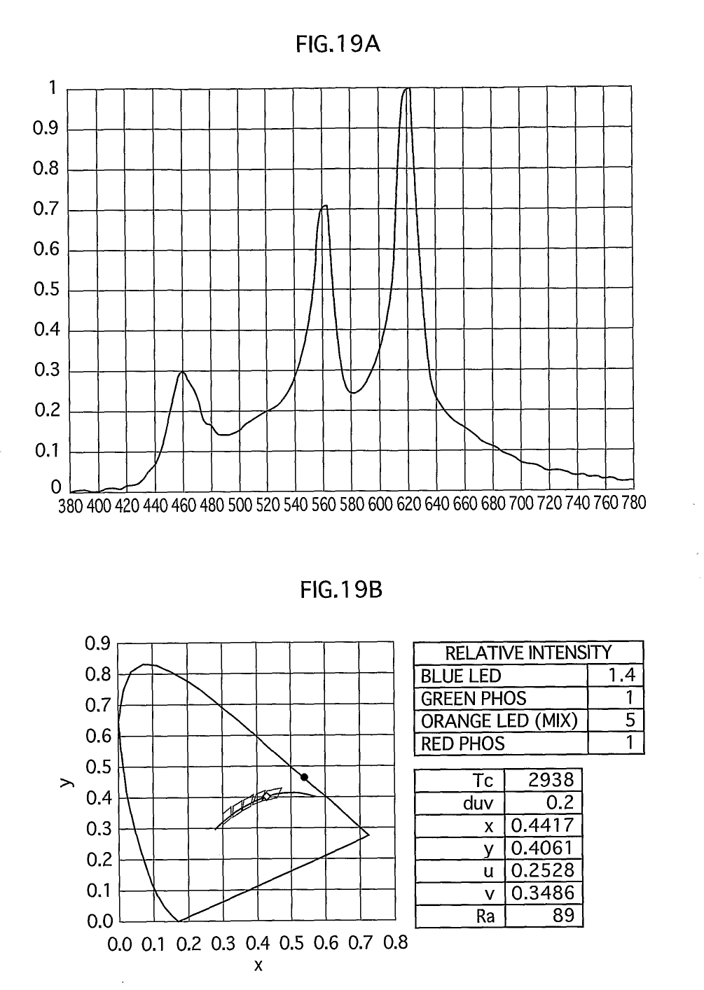

FIG. 19A is a diagram showing the spectral distribution of light emitted by causing both the white LED array 40 and the orange LED array 50 to illuminate at the same time. FIG. 19B shows the coordinates of the light source color on the chromaticity diagram, along with other data. The resultant white light exhibits the correlated color temperature Tc of 2938 K (color deviation duv=0.2) and the general color rendering index Ra of 89.

The mixture color may be arbitrarily varied within a wide range as indicated by the line (6) in FIG. 2, by adjusting the relative light intensity of the orange LED array 50 to the white LED array 40. Suppose, for example, the mixture color is varied so that the correlated color temperature Tc of 4402 sifts lower. In this case, when the correlated color temperature Tc is 2600 K, the value of duv is 3.7. When the correlated color temperature Tc is within this range, the value of duv is maintained within the range of −5≦duv≦10. In addition, when the correlated color temperature Tc is within the range of 2500≦Tc≦4402, the general color rendering index Ra is not less than 80. When the correlated color temperature Tc is within the range of 3030≦Tc≦4402, the general color rendering index Ra is not less than 90.

### EXAMPLE 7

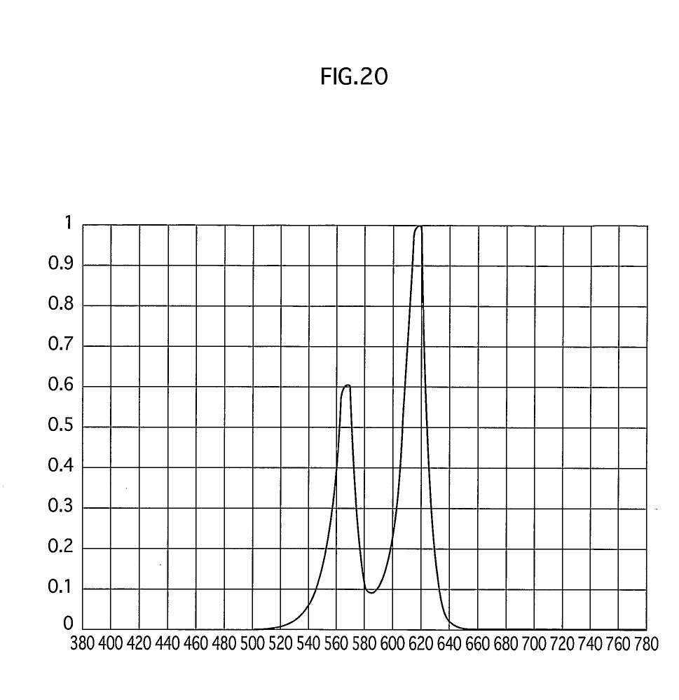

FIG. 20 is a diagram showing the spectral distribution of light emitted by the orange LED array 50 (FIG. 9) used in the example 7. The wavelength peaking at 620 nm is a wavelength component of the first LED array 42 (FIG. 9), and the wavelength peaking at 570 nm is a wavelength component of the second LED array 44 (FIG. 9).

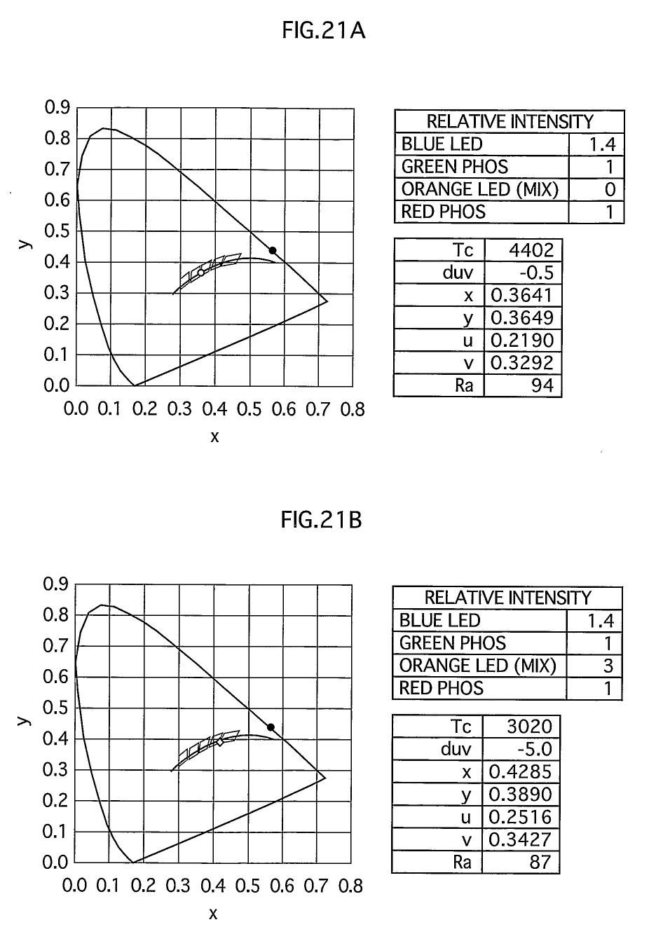

FIG. 21A shows, along with other data, the coordinates locating on the chromaticity diagram the light source color produced solely by the white LED array 40 (FIG. 9). The resultant white light exhibits the correlated color temperature Tc of 4402 K (color deviation duv=−0.5) and the general color rendering index Ra of 94.

FIG. 21B shows, along with other data, the coordinates locating on the chromaticity diagram the light source color produced by causing both the white LED array 40 and the orange LED array 50 to illuminate at the same time. The resultant white light exhibits the correlated color temperature Tc of 3020 K (color deviation duv=−5.0) and the general color rendering index Ra of 87.

The mixture color may be arbitrarily varied within a wide range as indicated by the line (7) in FIG. 2, by adjusting the relative light intensity of the orange LED array 50 to the white LED array 40. Suppose, for example, the mixture color is varied so that the correlated color temperature Tc of 4402 sifts lower. In this case, when the correlated color temperature Tc is 2600 K, the value of duv is −3.6. When the correlated color temperature Tc is within this range, the value of duv is maintained within the range of −5≦duv≦10. In addition, when the correlated color temperature Tc is within the range of 2600≦Tc≦4402, the general color rendering index Ra is not less than 80. When the correlated color temperature Tc is within the range of 3290≦Tc≦4402, the general color rendering index Ra is not less than 90.

### EXAMPLE 8

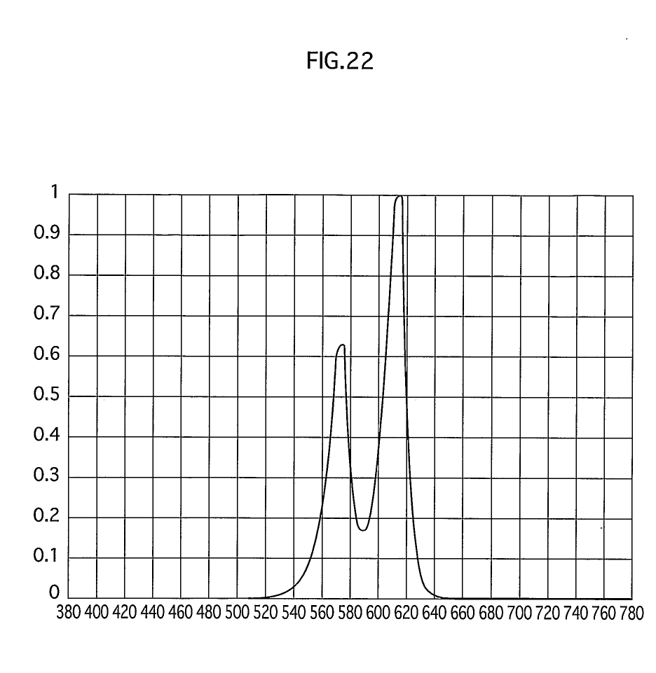

FIG. 22 is a diagram showing the spectral distribution of light emitted by the orange LED array 50 (FIG. 9) used in the example 8. The wavelength peaking at 615 nm is a wavelength component of the first LED array 42 (FIG. 9), and the wavelength peaking at 575 nm is a wavelength component of the second LED array 44 (FIG. 9).

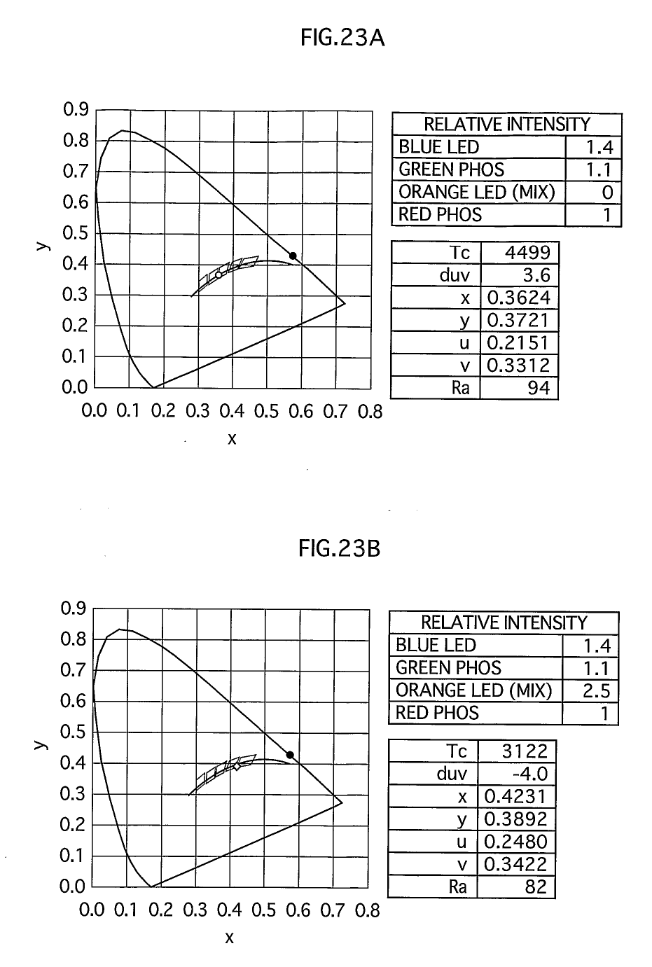

FIG. 23A shows, along with other data, the coordinates locating on the chromaticity diagram the light source color produced solely by the white LED array 40 (FIG. 9). The resultant white light exhibits the correlated color temperature Tc of 4499 K (color deviation duv=3.6) and the general color rendering index Ra of 94.

FIG. 23B shows, along with other data, the coordinates locating on the chromaticity diagram the light source color produced by causing both the white LED array 40 and the orange LED array 50 to illuminate at the same time. The resultant white light exhibits the correlated color temperature Tc of 3122 K (color deviation duv=−4.0) and the general color rendering index Ra of 82.

The mixture color may be arbitrarily varied within a wide range as indicated by the line (8) in FIG. 2, by adjusting the relative light intensity of the orange LED array 50 to the white LED array 40. Suppose, for example, the mixture color is varied so that the correlated color temperature Tc of 4499 sifts lower. In this case, when the correlated color temperature Tc is 2600 K, the value of duv is −4.2. When the correlated color temperature Tcis within this range, the value of duv is maintained within the range of −5≦duv≦10. In addition, whenthe correlated color temperature Tc is within the range of 3030≦Tc≦4499, the general color rendering index Ra is not less than 80. When the correlated color temperature Tc is within the range of 3800≦Tc≦4499, the general color rendering index Ra is not less than 90.

### EXAMPLE 9

The example 9 is basically the same as the example 3, except that NUV LED chips are used as the white LEDs 6 (FIG. 9).

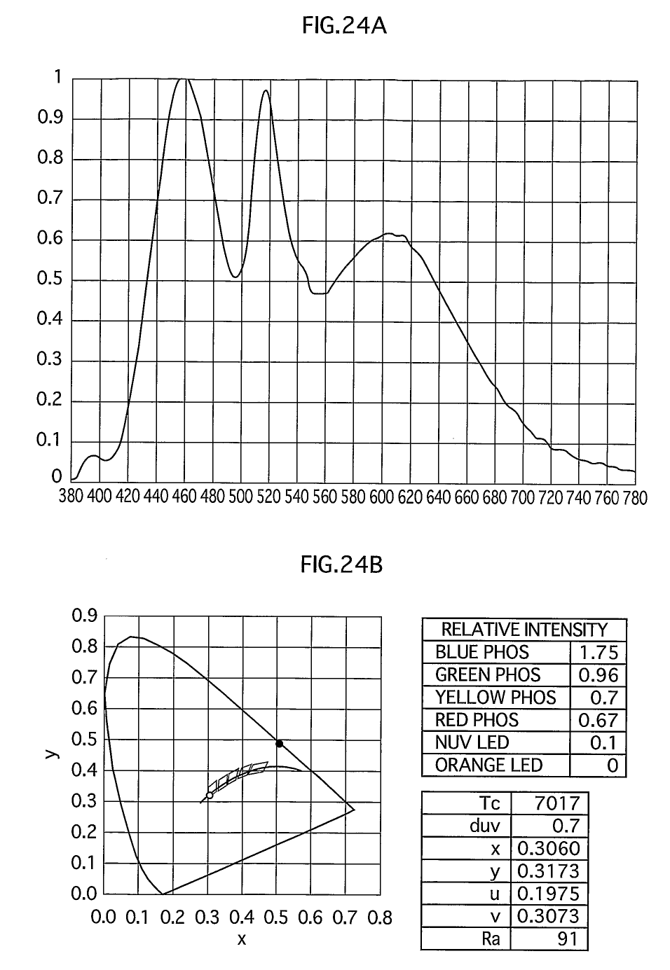

FIG. 24A is a diagram showing the spectral distribution of light emitted solely by the white LED array 40 (FIG. 9). FIG. 24B shows the coordinates of the light source color on the chromaticity diagram, along with other data. The resultant white light exhibits the correlated color temperature Tc of 7017 K (color deviation duv=0.7) and the general color rendering index Ra of 91.

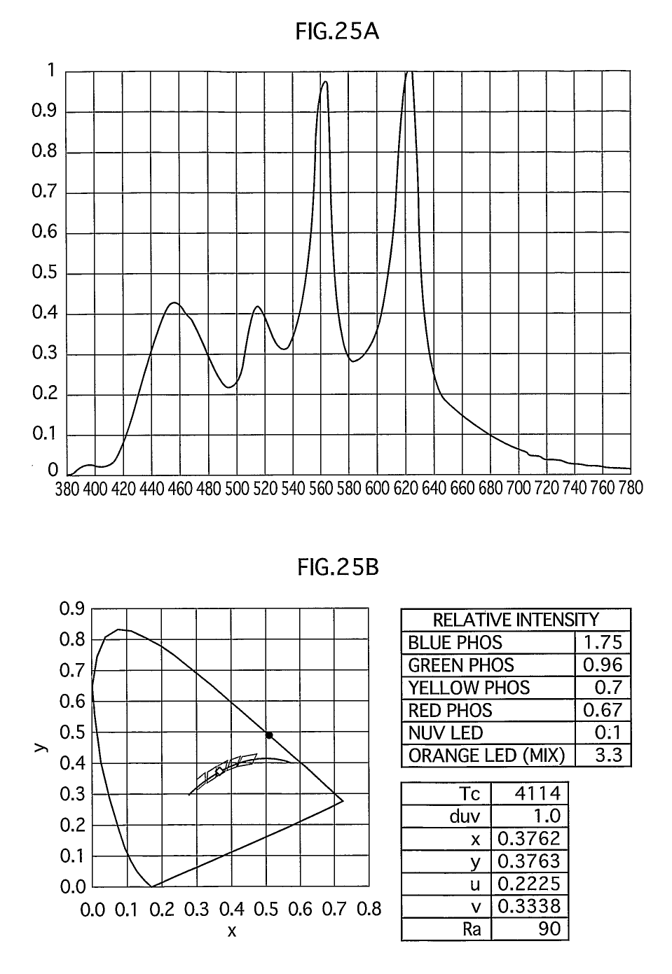

FIG. 25A is a diagram showing the spectral distribution of light emitted by causing both the white LED array 40 and the orange LED array 50 to illuminate at the same time. FIG. 25B shows the coordinates of the light source color on the chromaticity diagram, along with other data. The resultant white light exhibits the correlated color temperature Tc of 4114 K (color deviation duv=1.0) and the general color rendering index Ra of 90.

The mixture color may be arbitrarily varied within a wide range as indicated by the line (9) in FIG. 3, by adjusting the relative light intensity of the orange LED array 50 to the white LED array 40. When the correlated color temperature Tc is within the range of 7017≧Tc≧3120, the value of duv is maintained within the range of −5≦duv≦10. When the correlated color temperature Tc is within the range of 3460≦Tc≦7017, the general color rendering index Ra is not less than 80. When the correlated color temperature Tc is within the range of 4150≦Tc≦7017, the general color rendering index Ra is not less than 90.

### EXAMPLE 10

The example 10 is basically the same as the example 4, except that NUV LED chips are used as the white LEDs 6 (FIG. 9).

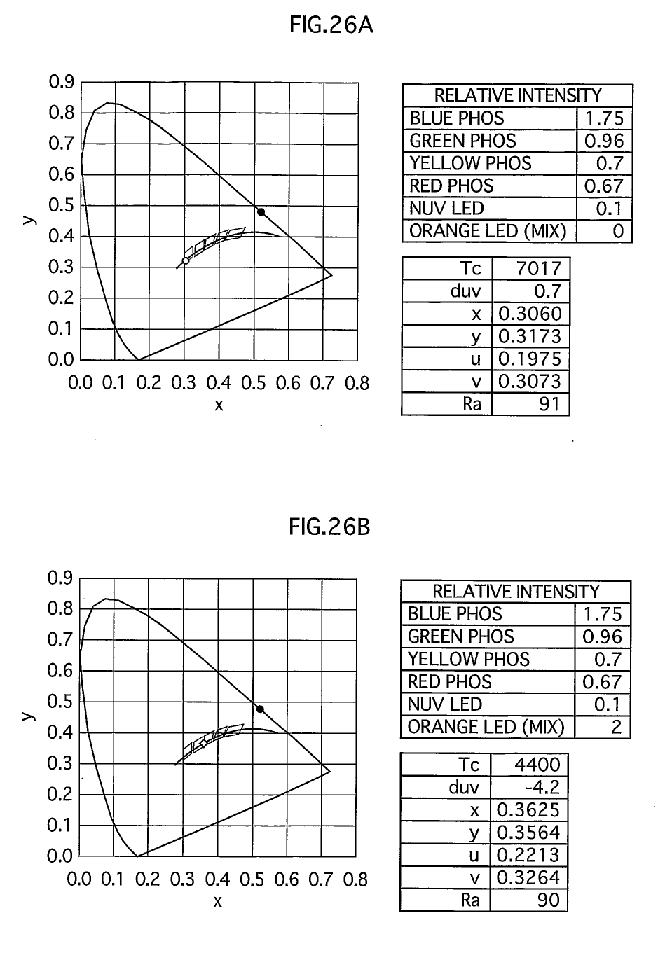

FIG. 26A shows, along with other data, the coordinates locating on the chromaticity diagram the light source color produced solely by the white LED array 40 (FIG. 9). The resultant white light exhibits the correlated color temperature Tc of 7017 K (color deviation duv=0.7) and the general color rendering index Ra of 91.

FIG. 26B shows, along with other data, the coordinates locating on the chromaticity diagram the light source color produced by causing both the white LED array 40 and the orange LED array 50 to illuminate at the same time. The resultant white light exhibits the correlated color temperature Tc of 4400 K (color deviation duv=−4.2) and the general color rendering index Ra of 90.

The mixture color may be arbitrarily varied within a wide range as indicated by the line (10) in FIG. 3, by adjusting the relative light intensity of the orange LED array 50 to the white LED array 40. When the correlated color temperature Tc is within the range of 7017≧Tc≧2550, the value of duv is maintained within the range of −5≦duv≦10. When the correlated color temperature Tc is within the range of 3560≦Tc≦7017, the general color rendering index Ra is not less than 80. When the correlated color temperature Tc is within the range of 4390≦Tc≦7017, the general color rendering index Ra is not less than 90.

### EXAMPLE 11

The example 11 is basically the same as the example 5, except that NUV LED chips are used as the white LEDs 6 (FIG. 9).

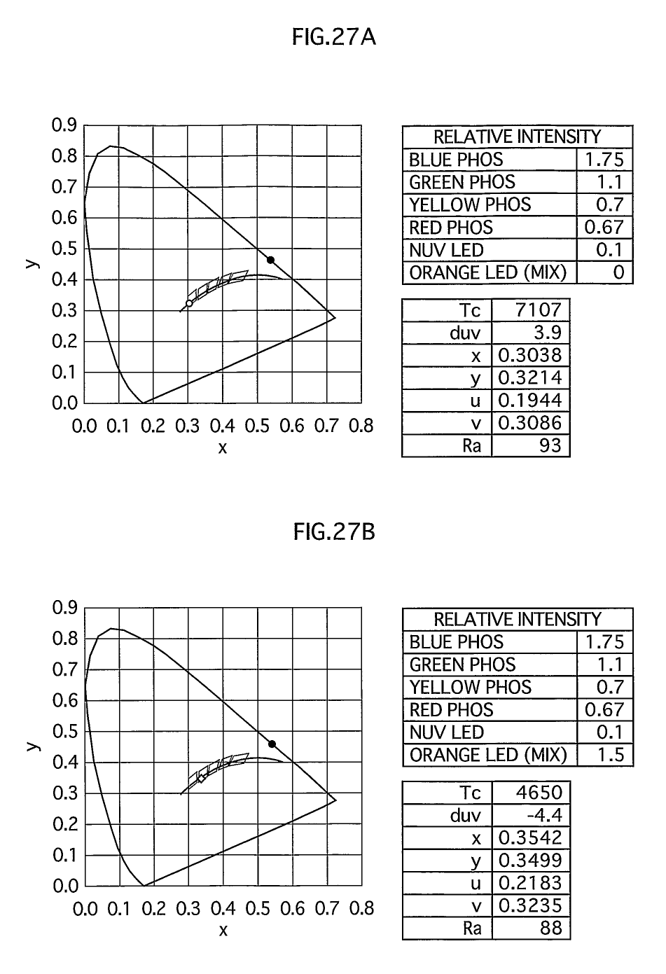

FIG. 27A shows, along with other data, the coordinates locating on the chromaticity diagram the light source color produced solely by the white LED array 40 (FIG. 9). The resultant white light exhibits the correlated color temperature Tc of 7107 K (color deviation duv=3.9) and the general color rendering index Ra of 93.

FIG. 27B shows, along with other data, the coordinates locating on the chromaticity diagram the light source color produced by causing both the white LED array 40 and the orange LED array 50 to illuminate at the same time. The resultant white light exhibits the correlated color temperature Tc of 4650 K (color deviation duv=−4.4) and the general color rendering index Ra of 88.

The mixture color may be arbitrarily varied within a wide range as indicated by the line (11) in FIG. 3, by adjusting the relative light intensity of the orange LED array 50 to the white LED array 40. Suppose, for example, the mixture color is varied so that the correlated color temperature Tc of 7107 sifts lower. In this case, when the correlated color temperature Tc is 2600 K, the value of duvis 0.0. When the correlated color temperature Tc is within this range, the value of duv is maintained within the range of −5≦duv≦10. When the correlated color temperature Tc is within the range of 3700≦Tc≦7107, the general color rendering index Ra is not less than 80. When the correlated color temperature Tc is within the range of 4900≦Tc≦7107, the general color rendering index Ra is not less than 90.

### EXAMPLE 12

The example 12 is basically the same as the example 7, except that NUV LED chips are used as the white LEDs 6 (FIG. 9).

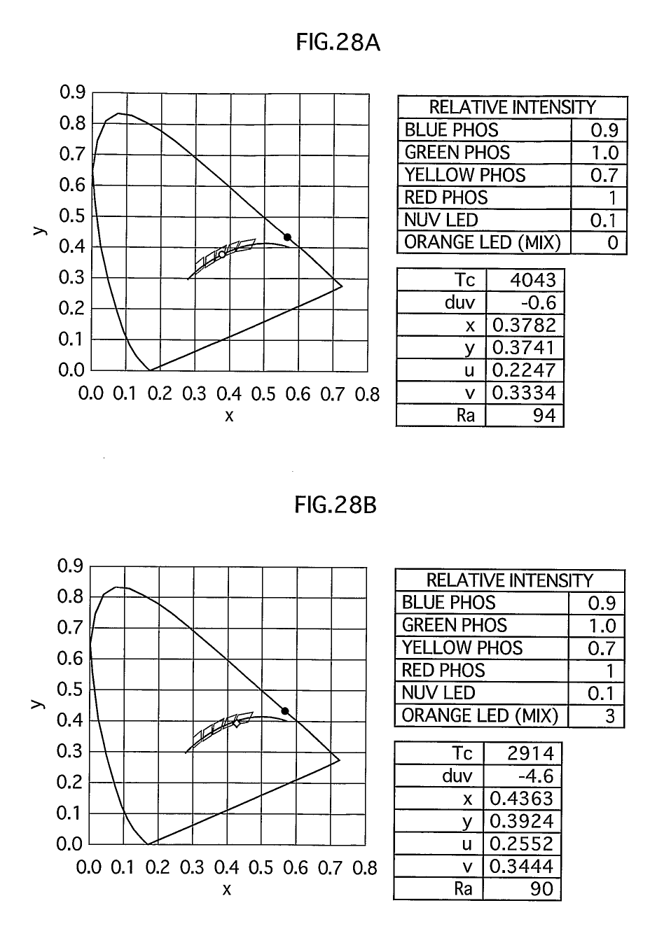

FIG. 28A shows, along with other data, the coordinates locating on the chromaticity diagram the light source color produced solely by the white LED array 40 (FIG. 9). The resultant white light exhibits the correlated color temperature Tc of 4043 K (color deviation duv=−0.6) and the general color rendering index Ra of 94.

FIG. 28B shows, along with other data, the coordinates locating on the chromaticity diagram the light source color produced by causing both the white LED array 40 and the orange LED array 50 to illuminate at the same time. The resultant white light exhibits the correlated color temperature Tc of 2914 K (color deviation duv=−4.6) and the general color rendering index Ra of 90.

The mixture color may be arbitrarily varied within a wide range as indicated by the line (12) in FIG. 3, by adjusting the relative light intensity of the orange LED array 50 to the white LED array 40. Suppose, for example, the mixture color is varied so that the correlated color temperature Tc of 4043 sifts lower. In this case, when the correlated color temperature Tc is 2600 K, the value of duv is −4.0. When the correlated color temperature Tc is within this range, the value of duv is maintained within the range of −5≦duv≦10. In addition, when the correlated color temperature Tc is within the range of 2400≦Tc≦4043, the general color rendering index Ra is not less than 80. When the correlated color temperature Tc is within the range of 2900≦Tc≦4043, the general color rendering index Ra is not less than 90.

### EXAMPLE 13

The example 13 is basically the same as the example 8, except that NUV LED chips are used as the white LEDs 6 (FIG. 9).

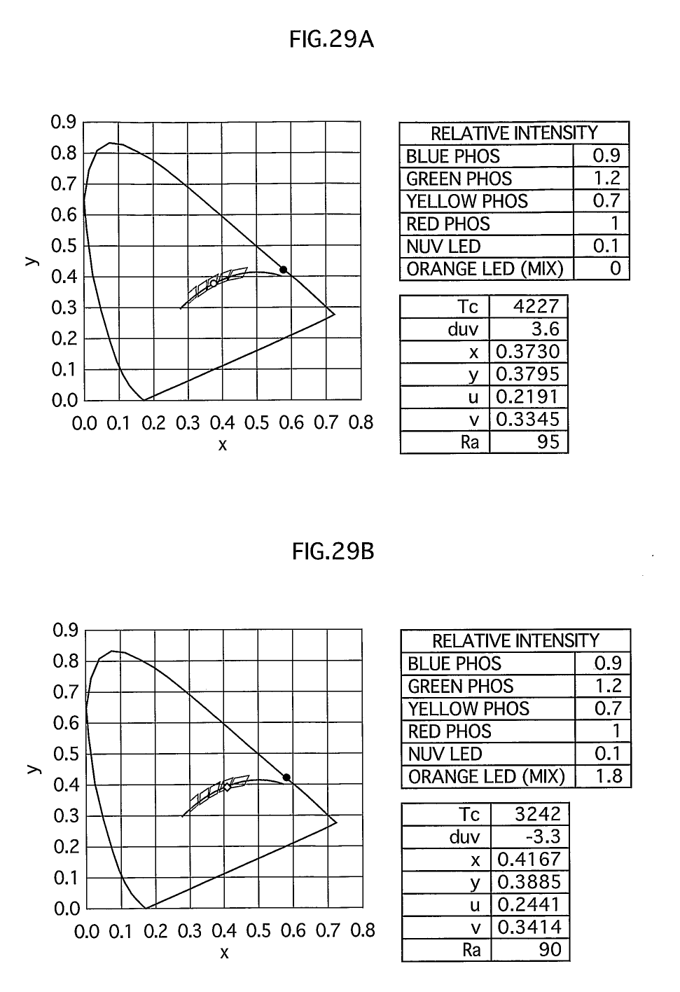

FIG. 29A shows, along with other data, the coordinates locating on the chromaticity diagram the light source color produced solely by the white LED array 40 (FIG. 9). The resultant white light exhibits the correlated color temperature Tc of 4227 K (color deviation duv=3.6) and the general color rendering index Ra of 95.

FIG. 29B shows, along with other data, the coordinates locating on the chromaticity diagram the light source color produced by causing both the white LED array 40 and the orange LED array 50 to illuminate at the same time. The resultant white light exhibits the correlated color temperature Tc of 3242 K (color deviation duv=−3.3) and the general color rendering index Ra of 90.

The mixture color may be arbitrarily varied within a wide range as indicated by the line (13) in FIG. 3, by adjusting the relative light intensity of the orange LED array 50 to the white LED array 40. Suppose, for example, the mixture color is varied so that the correlated color temperature Tc of 4227 sifts lower. In this case, when the correlated color temperature Tc is 2600 K, the value of duv is −4.0. When the correlated color temperature Tc is within this range, the value of duv is maintained within the range of −5≦duv≦10. When the correlated color temperature Tc is within the range of 2700≦Tc≦4227, the general color rendering index Ra is not less than 80. When the correlated color temperature Tc is within the range of 3270≦Tc≦4227, the general color rendering index Ra is not less than 90.

According to the embodiment 2 described above, in addition to the effect achieved by the embodiment 1, it is ensured that the light source color may be adjusted within a relatively wide range, while maintaining high color rendering property. This effect is described with reference to FIGS. 2 and 3. The line (1) in FIG. 2 and the line (2) in FIG. 3 represent the mixture colors adjusted according to the embodiment 1. As shown in the figures, the color rendering index Ra is maintained at 90 or higher from the right end of each line (corresponding to the light source color solely by the first light source) to a position at which light of the second light source is relatively low in intensity and thus is mixed at a relatively low ratio. Yet, as the intensity and the mixing ratio of light emitted by the second light source increases (as moving on the line toward the left), the color rendering index Ra drops abruptly. On the contrary, the lines representing the mixture color adjusted according to the embodiment 2 (the lines (3)-(7) in FIG. 2 and the lines (9)-(13) shown in FIG. 3), the color rendering index Ra is maintained at 90 or higher within a range wider than in the embodiment 1. This effect is attributed to that the second light source used for the color adjustment is composed of two types of light emitting elements (orange LEDs) having mutually different emission peak wavelengths.

Note that the second light source according the above embodiment is composed of two types of light emitting elements (LEDs). Yet, it is applicable to constitute the second light source with three or more types of light emitting elements (LEDs) having mutually different peak wavelengths. Also in this case, the light emitting elements (LEDs) are electrically connected in series or parallel, so that power is supplied to the light emitting elements by one power supply system.

### EMBODIMENT 3

An illumination source according to an embodiment 3 is provided with a third light source additionally to the components of the illumination source according to the embodiment 2.

Referring back to FIG. 1, the light source color of the third light source is represented by a third point P3 on the chromaticity diagram.

On the chromaticity diagram, the positional relation between the first and third points P1 and P3 is the same as the positional relation between the first and second points P1 and P2. That is, the third point P3 is at such a position that a line segment connecting the first and third points P1 and P3 is substantially in parallel with a tangent line to the Planckian Locus PL at a point on a line that is normal to the Planckian Locus and passes through the first point P1. Here, the meaning of “the line segment is substantially in parallel with the tangent line” is as described above. In addition, the third point P3 is located on the opposite side of the first point P1 from the second point P2.

As mentioned above, the illumination source according to the embodiment 3 is provided with the first to third light sources, but at most two of the light sources are made to emit light at the same time. That is, the first light source is made to emit light concurrently with either the second or third light source. Similarly to the embodiments 1 and 2, it is acceptable for only the first light source to be caused to emit light.

When the first and second light sources are made to emit light at the same time, the results are as described in the embodiment 2. In the embodiment 3, the first light source may be made emit light concurrently with the third light source located on the opposite side of the first point P1 from the second point P2, so that the mixture color is adjustable in a range wider than in the embodiment 2.

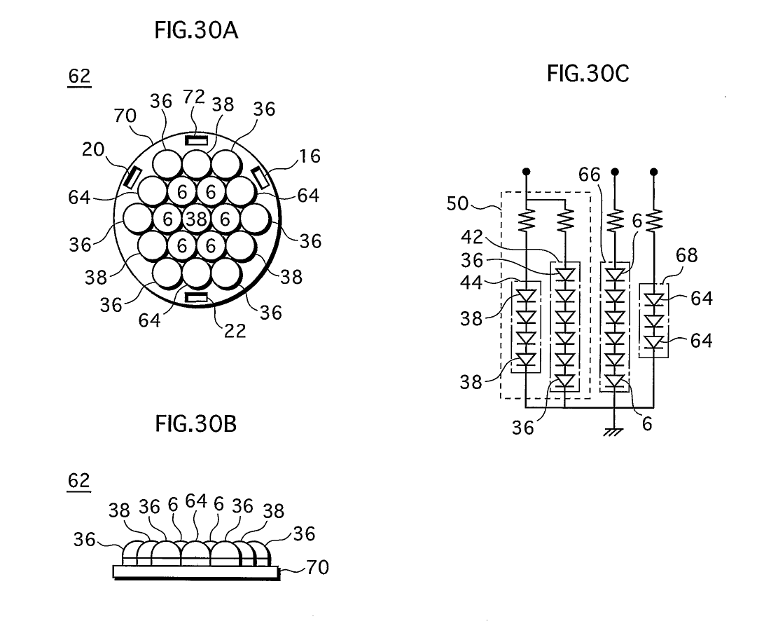

FIG. 30A is a plan view and FIG. 30B is a front view both showing the schematic structure of an illumination source 62 according to the embodiment 3. FIG. 30C is a circuit diagram. In FIG. 30, the same reference numerals are used to denote the same components as those of the illumination source 32 of the embodiment 2. No description is given to such components.

The illumination source 62 according to the embodiment 3 is provided with six white LEDs 6. The number white LEDs 6 is fewer by three than the nine white LEDs 6 provided in the illumination source 32 according to the embodiment 2. Instead of three white LEDs 6 that are made absent, the illumination source 62 is provided with three blue LEDs 64.

The six white LEDs 6 are serially connected to constitute a white LED array 66, whereas the three blue LEDs 64 are serially connected to constitute a blue LED array 68. In the embodiment 3, the first light source is constituted by the white LED array 66, whereas the third light source is constituted by the blue LED array 68. Note that the reference numeral 72 shown on a multi-layer printed wiring board 70 is a power supply terminal for the blue LED array 68.

Now, the embodiment 3 is described by way of a specific example 14.

### EXAMPLE 14

The white LEDs 6 used in the example 14 are NUV LED chips. The orange LED array 50 is identical to the one used in the example 7.

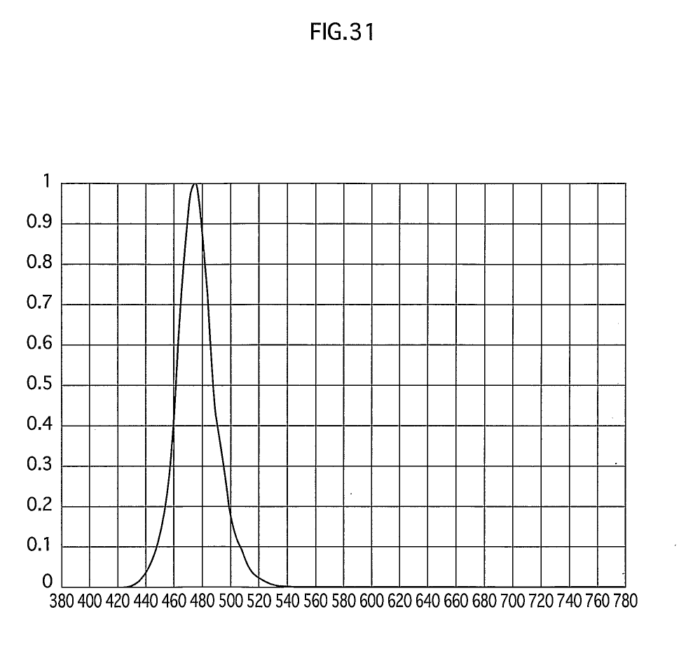

FIG. 31 is a diagram showing the spectral distribution of light emitted by the blue LEDs 64. As shown in the figure, the blue LEDs 64 used in this example have the emission peak wavelength at 475 nm.

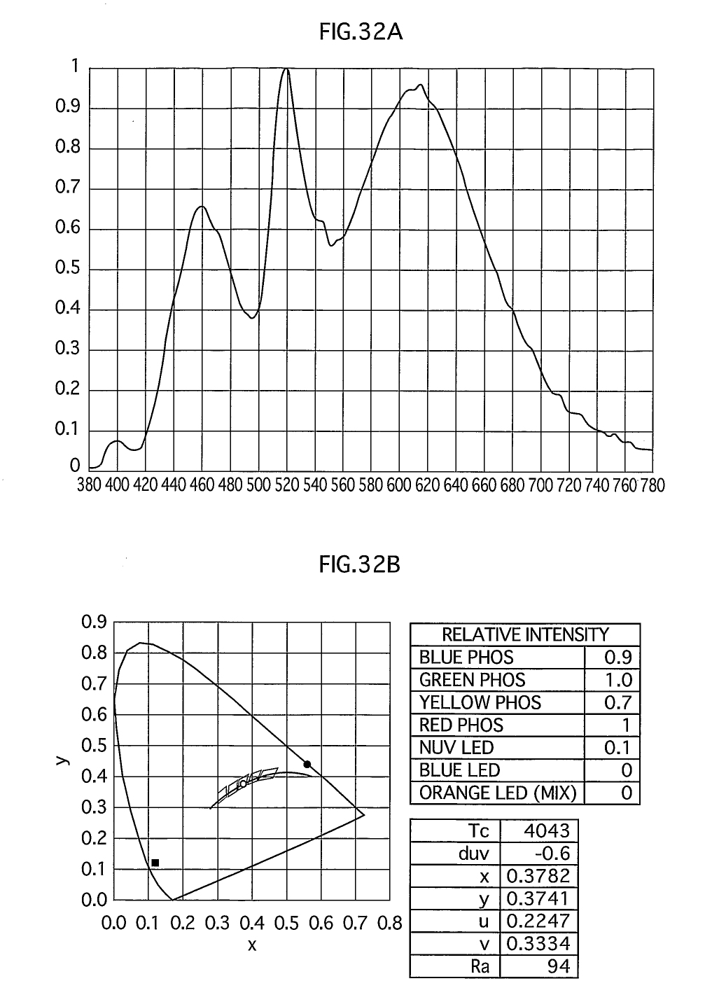

FIG. 32A is a diagram showing the spectral distribution of light emitted solely by the white LED array 66 (FIG. 30).

FIG. 32B shows the coordinates of the light source color on the chromaticity diagram, along with other data. The resultant white light exhibits the correlated color temperature Tc of 4043 K (color deviation duv=−0.6) and the general color rendering index Ra of 94. Note that a black square “▪” is shown on the chromaticity diagram at the position representing the light source color that would be produced given that the blue LED array 68 is made to solely emit light.

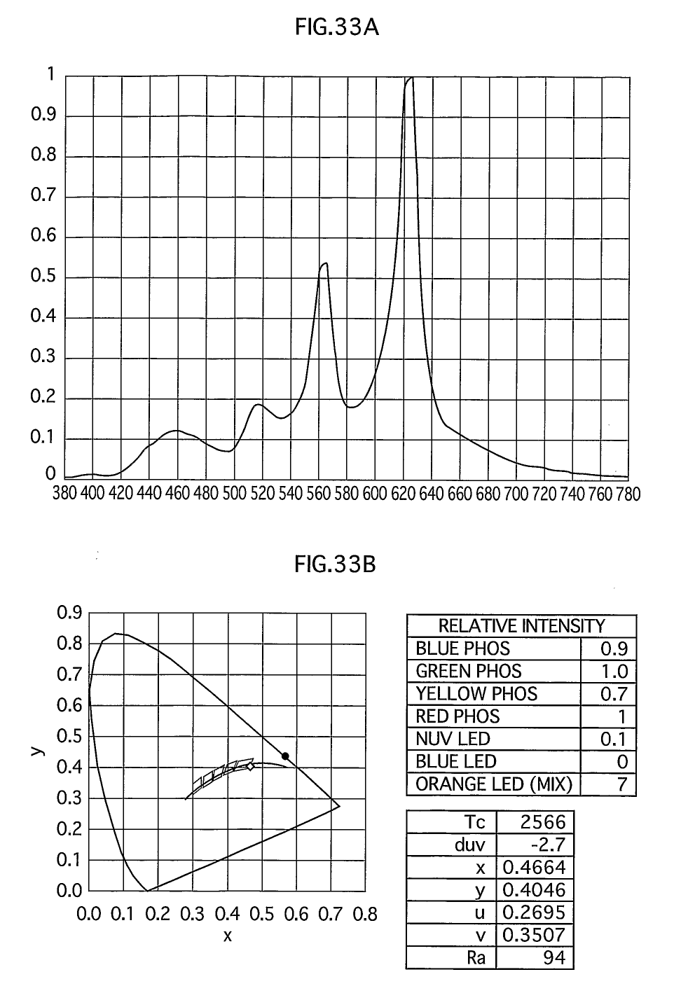

FIG. 33A is a diagram showing the spectral distribution of light emitted by causing both the white LED array 66 and the orange LED array 50 to illuminate at the same time. FIG. 33B shows the coordinates of the light source color on the chromaticity diagram, along with other data. The resultant white light exhibits the correlated color temperature Tc of 2566 K (color deviation duv=−2.7) and the general color rendering index Ra of 94.

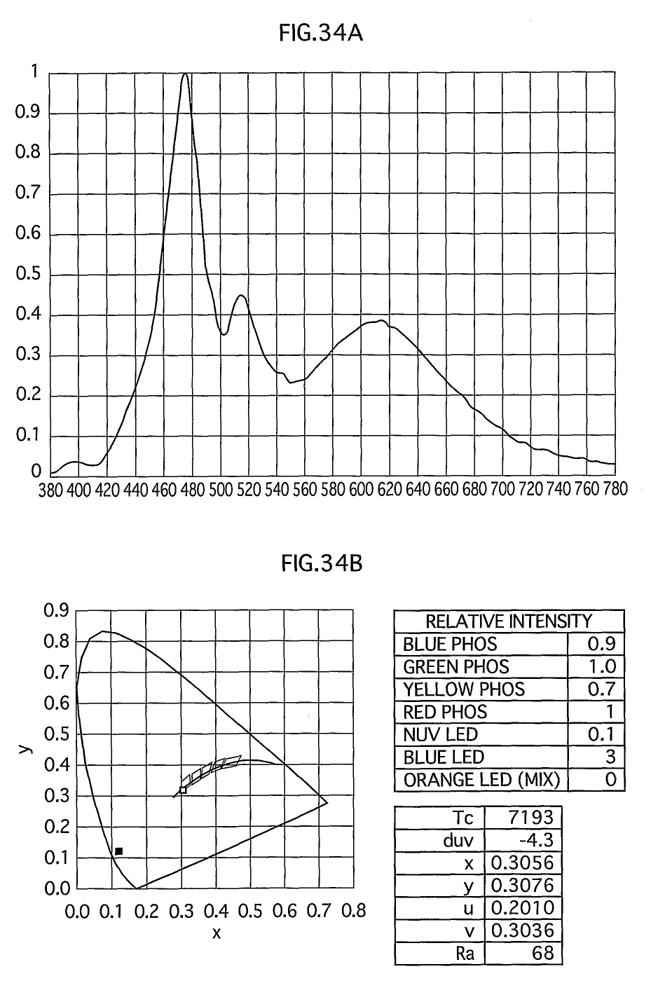

FIG. 34A is a diagram showing the spectral distribution of light emitted by causing both the white LED array 66 and the blue LED array 68 to illuminate at the same time. FIG. 34B shows the coordinates of the light source color (indicated by a white square “□”) on the chromaticity diagram, along with other data. The resultant white light exhibits the correlated color temperature Tc of 7193 K (color deviation duv=−4.3) and the general color rendering index Ra of 68.

The mixture color may be arbitrarily varied within a wide range as indicated by the line (14) in FIG. 3, by adjusting the relative light intensity of the orange LED array 50 or of the blue LED array 68 to the white LED array 66. When the correlated color temperature Tc is within the range of 7100≧Tc≧2600, the value of duv is maintained within the range of −5≦duv≦10. Specifically, when the correlated color temperature Tc is 7100, the value of duv is −4.3. When the correlated color temperature Tc is 2600, the value of duv is −2.9. In addition, when the correlated color temperature Tc is within the range of 2500≦Tc≦5370, the general color rendering index Ra is not less than 80. When the correlated color temperature Tc is within the range of 2500≦Tc≦4380, the general color rendering index Ra is not less than 90.

According to the embodiment 3 above, the light source color of a single illumination source may be varied (adjusted) within a range wider than in the embodiments 1 and 2. This effect is described with reference to FIGS. 2 and 3. The line (14) in FIG. 3 represents the mixture colors adjusted according to the embodiment 3. As apparent from FIGS. 3 and 2, the line (14) in FIG. 3 is longer along the horizontal axis representing the correlated color temperatures, than the lines representing the light source color adjustment according to the embodiments 1 and 2. This means that the light source color is adjustable within a wider range of correlated color temperatures. Furthermore, since the color adjustment is made by concurrently illuminating at most two light sources, the control required herein remains easier than conventional control of power supplies to LEDs of R, G, and B (control of three power supply systems).

Up to this point, the present invention has been described by way of the embodiments. It should be naturally appreciated, however, that the present invention is in no way limited to the specific embodiments described above, and various modification including the following may be made.

(1) The numbers and types of LEDs used to constitute the first to third light sources are not limited to the specific examples mentioned above. Any other types of LEDs may be used and any numbers of LEDs may be used.

(2) The phosphors used to constitute the first light source are not limited to the specific phosphors mentioned above.

(3) In the above embodiments, each illumination source is composed of bullet-shaped LEDs. Yet, the present invention is not limited thereto. It is applicable to assemble an illumination source with chip-on-board technology. That is, the illumination source may be assembled by directly arranging (mounting) LED chips on a circuit board at high packaging density.

(4) In the above embodiments, the power supply (current value) to the first light source is kept constant, while the power supply (current value) to the second or third light source is varied to adjust the light source color. Yet, it is applicable to additionally vary the power supply to the first light source. This modification allows the light source color to be adjusted (the light intensity to be controlled) in a wider range.

In this case, it is applicable to increase and decrease the intensity of the first light source in accordance with the increase and decrease of the intensity of the second or third light source, so that the intensity of the illumination source as a whole is kept constant. In other words, it is applicable to adjust the light source color, while keeping the intensity of the illumination source at a constant level.

### INDUSTRIAL APPLICABILITY

The present invention is highly and suitably usable in the field of illumination in which it is desirable that a light source is variable with simple control, while keeping the natural appearance.

1. An illumination source comprising:
a first light source operable to emit light of a first color represented by a first point on a 1931 CIE chromaticity diagram; and
a second light source operable to emit light of a second color represented by a second point on the 1931 CIE chromaticity diagram, a light intensity of the second light source being variable in accordance with a power supply, wherein
the first point is substantially on a Planckian Locus,
the second point is at such a position that a line segment connecting the first and second points is substantially in parallel with a tangent line to the Planckian Locus, the tangent line having a point of tangency on a line that is normal to the Planckian Locus and passes through the first point, and
the illumination source emits light of a mixture color of the first and second colors.

2. The illumination source of claim 1, wherein
the second light source includes a first light emitting element and a second light emitting element that are electrically connected in series or in parallel, the first and second light emitting elements having mutually different peak wavelengths.

3. The illumination source of claim 2, further comprising:
a third light source operable to emit light of a third light source color represented by a third point on the 1931 CIE chromaticity diagram, a light intensity of the third light source being variable in accordance with a power supply, wherein
the third point is located on an opposite side of the first point to the second point and at such a position that a line segment connecting the first and third points is substantially in parallel with the tangent line.

4. The illumination source of claim 3, wherein
the first light source includes: a near-ultraviolet emitting element operable to emit near-ultraviolet light; and
blue, green, yellow, and red phosphors operable to convert the near-ultraviolet light to light of respective colors.

5. The illumination source of claim 4, wherein
the first light emitting element, the second light emitting element, and the near-ultraviolet emitting elements are LEDs.

6. The illumination source of claim 1, further comprising
a third light source operable to emit light of a third light source color represented by a third point on the 1931 CIE chromaticity diagram, a light intensity of the third light source being variable in accordance with a power supply, wherein
the third point is located on an opposite side of the first point to the second point and at such a position that a line segment connecting the first and third points is substantially in parallel with the tangent line.

7. The illumination source of claim 6, wherein
the first light source includes: a near-ultraviolet emitting element operable to emit near-ultraviolet light; and blue, green, yellow, and red phosphors operable to convert the near-ultraviolet light to light of respective colors.

8. The illumination source of claim 7, wherein
the near-ultraviolet emitting element is an LED.

9. The illumination source of claim 1, wherein
the first light source includes: a blue light emitting element operable to emit blue light; and green and red phosphors operable to convert the blue light to light of respective colors.

10. The illumination source of claim 9, wherein
the blue light emitting element is an LED.

11. The illumination source of claim 1, wherein
the first light source includes: a near-ultraviolet emitting element operable to emit near-ultraviolet light; and blue, green, yellow, and red phosphors operable to convert the near-ultraviolet light to light of respective colors.

12. The illumination source of claim 11, wherein
the near-ultraviolet emitting element is an LED.

13. The illumination source of claim 1, wherein
a light intensity of the first light source is variable in accordance with a power supply.
